(19) United States
(12) Patent Application Publication
(10) Pub. No.: US 2025/0086674 A1
(43) Pub. Date: Mar. 13, 2025

(54) ENGAGEMENT MEASUREMENT AND LEARNING AS A SERVICE

(71) Applicant: Dolby Laboratories Licensing Corporation, San Francisco, CA (US)

(72) Inventors: Dylan James HARPER-HARRIS, Sydney (AU); Richard J. CARTWRIGHT, KILLARA (AU); Richard Walter MARTY, Marina Del Rey, CA (US); Siqi PAN, Wolli Creek (AU); Jianbo MA, Macquarie Park (AU); Ron GELLER, Manhattan Beach, CA (US); Daniel Steven TEMPLETON, San Francisco, CA (US); Cedric JOGUET-RECCORDON, San Francisco, CA (US); Yin-Lee HO, Zetland (AU); Benjamin SOUTHWELL, Gledswood Hills (AU)

(73) Assignee: Dolby Laboratories Licensing Corporation, San Francisco, CA (US)

(21) Appl. No.: 18/883,257

(22) Filed: Sep. 12, 2024

Related U.S. Application Data
(60) Provisional application No. 63/691,171, filed on Sep. 5, 2024.
(60) Provisional application No. 63/582,359, filed on Sep. 13, 2023.

(51) Int. Cl. G06Q 30/0242; G06Q 30/0282

(52) U.S. Cl. CPC G06Q 30/0246; G06Q 30/0282

(57) ABSTRACT

An apparatus may include an interface system and a first local control system. The first local control system may be configured to: receive first sensor data from a first preview environment while a content stream is being presented in the first preview environment; generate, based at least in part on the first sensor data, first user engagement data corresponding to one or more people in the first preview environment, the first user engagement data indicating estimated engagement with presented content of the content stream; output, via the interface system, either the first user engagement data, the first sensor data, or both, to a data aggregation device; and determine, based at least in part on user preference data, whether to provide at least some of the first user engagement data, at least some of the first sensor data, or both, to one or more machine learning (ML) models.

### CROSS-REFERENCE TO RELATED APPLICATIONS

This application claims priority to U.S. provisional application 63/582,359, filed 13 Sep. 2023 and U.S. provisional application 63/691,171, filed 5 Sep. 2024 all of which are incorporated herein by reference in their entirety.

### TECHNICAL FIELD

This disclosure pertains to devices, systems and methods for estimating user engagement with content.

### BACKGROUND

Some methods, devices and systems for estimating user engagement or attention, such as user attention to advertising content, are known. (The terms “engagement” and “attention” are used synonymously herein.) Previously-implemented approaches to estimating user attention to media content generally involve assessing a person's rating of the content after the person has consumed it, such as after the person has finished watching a movie or an episode of a television program, after the user has played an online game, etc. Although existing devices, systems and methods can provide benefits in some contexts, improved devices, systems and methods would be desirable.

### SUMMARY

At least some aspects of the present disclosure may be implemented via apparatus. For example, one or more devices (e.g., a system that includes one or more devices) may be capable of performing, at least in part, the methods disclosed herein. In some implementations, an apparatus is, or includes, an interface system and a control system.

The interface system may be configured for communication with one or more other devices of an environment. The interface system may include one or more network interfaces, one or more external device interfaces (such as one or more universal serial bus (USB) interfaces), or combinations thereof. According to some implementations, the interface system may include one or more wireless interfaces.

The control system may include one or more general purpose single- or multi-chip processors, digital signal processors (DSPs), application specific integrated circuits (ASICs), field programmable gate arrays (FPGAs) or other programmable logic devices, discrete gates or transistor logic, discrete hardware components, or combinations thereof. The control system may be configured for implementing some or all of the methods disclosed herein.

According to some examples, the control system may be a first local control system of a preview environment. In some examples, the first local control system may be configured to receive, via the interface system, first sensor data from one or more sensors in the first preview environment while a content stream is being presented in the first preview environment.

In some examples, the first local control system may be configured to generate, based at least in part on the first sensor data, first user engagement data corresponding to one or more people in the first preview environment. The first user engagement data may indicate estimated engagement with presented content of the content stream. According to some examples, the first local control system may be configured to output, via the interface system, at least some of the first user engagement data, at least some of the first sensor data, or both, to a data aggregation device. In some examples, the first local control system may be configured to determine, based at least in part on user preference data, whether to provide at least some of the first user engagement data, at least some of the first sensor data, or both, to one or more machine learning (ML) models.

According to some examples, one of the one or more ML models may be a first local ML model that is configured to be trained at least in part on at least some of the first user engagement data, at least some of the first sensor data, or both, from the first preview environment. In some such examples, the first local control system may be configured to implement the first local ML model.

In some examples, one of the one or more ML models may be a federated ML model that is configured to be trained at least in part on user engagement data from a plurality of preview environments, sensor data from a plurality of preview environments, or both. The federated ML model may, for example, be implemented by one or more remote devices that are not in the first preview environment. In some examples, the federated ML model may be implemented by one or more servers.

According to some examples, the first local control system may be configured to receive, from the federated ML model and via the interface system, updated federated ML model data and to update the first local ML model according to the updated federated ML model data. In some instances, the first local control system may determine to provide the first user engagement data or the first sensor data to the first local ML model. However, in some instances, the first local control system may determine not to provide the first user engagement data or the first sensor data to the first local ML model. In some examples, the updated federated ML model data may correspond to a demographic group of at least one of the one or more people in the first preview environment.

In some examples, the federated ML model may be configured to be trained at least in part on updated local ML model data from each of a plurality of local ML models. In some such examples, each of the plurality of local ML models may correspond to one preview environment of a plurality of preview environments. According to some examples, the first local control system may be configured to determine when to provide updated local ML model data from the first local ML model. In some such examples, the first local control system may be configured to provide updated local ML model data from the first local ML model after the first local ML model has processed user engagement data, sensor data, or both, from a complete session of content consumption in the first preview environment. Alternatively, or additionally, the first local control system may be configured to provide updated local ML model data from the first local ML model after the first local ML model has updated user engagement data according to one or more user responses to one or more user prompts.

According to some examples, the first local control system may be configured to provide selected sensor data to the first local ML model. In some such examples, the selected sensor data may include some, but not all, types of sensor data obtained in the first preview environment. In some examples, the selected sensor data may correspond to user preference data obtained by the first local control system.

In some examples, the first local control system may be configured to generate the first user engagement data according to a set of one or more detectable engagement types obtained by the first local control system. According to some examples, the set of one or more detectable engagement types may correspond to user preference data obtained by the first local control system. In some examples, the set of one or more detectable engagement types may correspond to detectable engagement data provided with the content stream. According to some examples, the detectable engagement data may be indicated by metadata received with the content stream. In some examples, first detectable engagement data corresponding to a first portion of the content stream may differ from second detectable engagement data corresponding to a second portion of the content stream.

According to some examples, the first local control system may be configured to provide one or more user prompts, each of the one or more user prompts corresponding to a time interval of the content stream. In some examples, the first local control system may be configured to receive responsive user input corresponding to at least one of the one or more user prompts. According to some examples, the first local control system may be configured to generate at least some of the first user engagement data based, at least in part, on the responsive user input.

At least some aspects of the present disclosure may be implemented via one or more methods. In some instances, the method(s) may be implemented, at least in part, by a control system and/or via instructions (e.g., software) stored on one or more non-transitory media. Some disclosed methods may involve receiving, by a local control system of a first preview environment, first sensor data from one or more sensors in the first preview environment while a content stream is being presented in the first preview environment.

Some disclosed methods may involve generating, by the local control system and based at least in part on the first sensor data, first user engagement data corresponding to one or more people in the first preview environment. The first user engagement data may indicate estimated engagement with presented content of the content stream.

Some disclosed methods may involve outputting, by the local control system, either at least some of the first user engagement data, at least some of the first sensor data, or both, to a data aggregation device. Some disclosed methods may involve determining, by the local control system and based at least in part on user preference data, whether to provide at least some of the first user engagement data, at least some of the first sensor data, or both, to one or more machine learning (ML) models.

According to some examples, one of the one or more ML models may be a first local ML model, implemented by the first local control system. In some examples, the first local ML model may be configured to be trained at least in part on at least some of the first user engagement data, at least some of the first sensor data, or both, from the first preview environment.

In some examples, one of the one or more ML models may be a federated ML model that is configured to be trained at least in part on user engagement data from a plurality of preview environments, sensor data from a plurality of preview environments, or both. According to some examples, the federated ML model may be implemented by one or more remote devices that are not in the first preview environment.

Some disclosed methods may involve receiving, from the federated ML model and by the local control system, updated federated ML model data. Some disclosed methods may involve updating, by the local control system, the first local ML model according to the updated federated ML model data.

Some or all of the operations, functions and/or methods described herein may be performed by one or more devices according to instructions (e.g., software) stored on one or more non-transitory media. Such non-transitory media may include memory devices such as those described herein, including but not limited to random access memory (RAM) devices, read-only memory (ROM) devices, etc. Accordingly, some innovative aspects of the subject matter described in this disclosure can be implemented via one or more non-transitory media having software stored thereon.

According to some examples, one or more non-transitory media may have instructions stored thereon for controlling one or more devices to perform one or more methods. Some such methods may involve receiving, by a local control system of a first preview environment, first sensor data from one or more sensors in the first preview environment while a content stream is being presented in the first preview environment.

Some methods may involve generating, by the local control system and based at least in part on the first sensor data, first user engagement data corresponding to one or more people in the first preview environment. The first user engagement data may indicate estimated engagement with presented content of the content stream.

Some methods may involve outputting, by the local control system, either at least some of the first user engagement data, at least some of the first sensor data, or both, to a data aggregation device. Some methods may involve determining, by the local control system and based at least in part on user preference data, whether to provide at least some of the first user engagement data, at least some of the first sensor data, or both, to one or more machine learning (ML) models.

According to some examples, one of the one or more ML models may be a first local ML model, implemented by the first local control system. In some examples, the first local ML model may be configured to be trained at least in part on at least some of the first user engagement data, at least some of the first sensor data, or both, from the first preview environment.

In some examples, one of the one or more ML models may be a federated ML model that is configured to be trained at least in part on user engagement data from a plurality of preview environments, sensor data from a plurality of preview environments, or both. According to some examples, the federated ML model may be implemented by one or more remote devices that are not in the first preview environment.

Some methods may involve receiving, from the federated ML model and by the local control system, updated federated ML model data. Some methods may involve updating, by the local control system, the first local ML model according to the updated federated ML model data.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

Like reference numbers and designations in the various drawings indicate like elements.

FIG. 1 is a block diagram that shows examples of components of an apparatus capable of implementing various aspects of this disclosure.

FIG. 2A shows an environment that includes examples of components capable of implementing various aspects of this disclosure.

FIG. 2B shows another environment that includes examples of components capable of implementing various aspects of this disclosure.

FIG. 3 shows components of an Attention Tracking System (ATS) residing in a playback environment according to one example.

FIG. 4 shows components of a neural network capable of performing real-time acoustic event detection according to one example.

FIG. 5 shows components of a device analytics engine configured for performing real-time pose estimation according to one example.

FIG. 6 shows examples of inputs and outputs of an online preview community (OPC).

FIG. 7 shows examples of OPC elements.

FIG. 8 shows additional examples of OPC elements.

FIG. 9 shows additional examples of OPC elements.

FIG. 10 shows additional examples of OPC elements.

FIG. 11 shows example elements of a content report.

FIG. 12A shows an example of a graphical user interface (GUI) for presenting an interactive engagement analysis.

FIG. 12B shows another example of a GUI for presenting an interactive engagement analysis.

FIG. 12C shows another example of a GUI for presenting an interactive engagement analysis.

FIG. 12D shows another example of a GUI for presenting an interactive engagement analysis.

FIG. 12E shows another example of a GUI for presenting an interactive engagement analysis.

FIG. 13A shows an example of a GUI for presenting a character-specific engagement analysis.

FIG. 13B shows another example of a GUI for presenting a character-specific engagement analysis.

FIG. 14A shows an example of a GUI for presenting an engagement analysis corresponding to various detected previewer reactions.

FIG. 14B shows another example of a GUI for presenting an engagement analysis corresponding to various detected previewer reactions.

FIG. 14C shows an example of a GUI for presenting an engagement analysis corresponding to detected previewer reactions that explicitly indicate current levels of engagement.

FIG. 15A shows example elements of a portion of an ad report.

FIG. 15B shows example elements of another portion of an ad report.

FIG. 15C shows example elements of another portion of an ad report.

FIG. 16 is a flow diagram that outlines one example of a disclosed method.

### DETAILED DESCRIPTION OF EMBODIMENTS

We currently spend a lot of time consuming media content, including but not limited to audiovisual content, interacting with media content, or combinations thereof. (For the sakes of brevity and convenience, both consuming and interacting with media content may be referred to herein as “consuming” media content.) Consuming media content may involve viewing a television program or a movie, watching or listening to an advertisement, listening to music or a podcast, gaming, video conferencing, participating in an online learning course, etc. Accordingly, movies, online games, video games, video conferences, advertisements, online learning courses, podcasts, streamed music, etc., may be referred to herein as types of media content.

Previously-implemented approaches to estimating user attention to media content such as movies, television programs, etc., do not generally take into account how a person reacts while the person is in the process of consuming the media content. Instead, a person's impressions may be assessed according to the person's rating of the content after the user has consumed it, such as after the person has finished watching a movie or an episode of a television program, after the user has played an online game, etc.

Some previously-implemented approaches to estimating user engagement involve pilot studies, in which the organizers of the pilot study are able to observe an audience's response to the content. Obtaining feedback via a pilot study can be slow, in part because content producers or other organizers of the pilot study must select and gather an audience for a pilot study, etc. Alternatively, some studios allow people to preview content remotely and return a survey response back to the producers to evaluate how the content performed. The “survey response” approach can allow for faster turn-around of a content performance report, as compared to a pilot study approach, but the survey responses lack information about how the audience responded in real-time throughout the duration of the content. Some other previously-implemented approaches involve tracking a single user's engagement to content being played on a close-range viewing device, such as a laptop or tablet. Some disclosed examples resolve problems with the previously-implemented approaches, such as being able to track only a single user and the environment not being able to be representative of a non-close range viewing experience. Note that tracking multiple user engagement at non-close range is a much harder problem.

According to previously-implemented methods, when new content is released there is little information about what advertisements or “ads” to place in the content or where in the content to place the ads. Some entities advertize products that a person may like based on a stored user profile that is obtained by tracking the person's online activity, for example using information obtained via “cookies.” However, in the current era many people are taking measures to enhance their privacy and cookies are being phased out. Accordingly, entities often do not have information regarding who is watching distributed content.

Some disclosed examples for addressing the foregoing problems involve implementing what may be referred to herein as an online preview community (OPC). According to some such examples an entity may establish an OPC in which many users sign up to preview pre-release content. Such OPCs may provide information that enable the prompt generation of content reports with detailed information about how various people engaged in real time. In some examples, the problems involve with preserving anonymity whilst performing targeted advertising may also be resolved using an OPC. For example, the OPC, or a device or system implementing the OPC, may be configured to produce an ad report indicating the engagement of previewers throughout the duration of the content, e.g., according to groups of previewers classified by demography, personal interests, etc. Using this ad report, content distributers can make informed decisions about ad placement and targeting whilst preserving viewer anonymity.

Some disclosed examples involve implementing what may be referred to herein as an Attention Tracking System (ATS) as part of an OPC. Some disclosed techniques and systems utilize available sensors in an environment to detect user reactions, or lack thereof, in real time. Some such examples involve using one or more cameras, eye trackers, ambient light sensors, microphones, wearable sensors, or combinations thereof. For example, one or more microphones may reside in one or more smart speakers, one or more phones, one or more televisions (TVs), or combinations thereof. Such sensors may include sensors for measuring galvanic skin response, e.g., such as those in smart watches. Using some or all of these technologies in combination allows for an enhanced user attention tracking system to be achieved. Some such examples involve measuring a person's level of engagement, heart rate, cognitive load, attention, interest, etc., while the person is consuming media content by watching a television, playing a game, participating in a telecommunication experience (such as a videoconference, a video seminar, etc.), listening to a podcast, etc. Some examples implement recent advancements in AI such as automatic speech recognition (ASR), emotion recognition, gaze tracking, or combinations thereof.

### What is Meant by “Attention” or “Engagement” ?

User attention, engagement, response and reaction may be used interchangeably throughout this disclosure. In some embodiments of the proposed techniques and systems, user response may refer to any form of attention to content, such as an audible reaction, a body pose, a physical gesture, a heartrate, wearing a content-related article of clothing, etc. Attention may take many forms such as binary (e.g., a user said “Yes”), on a spectrum (e.g., excitement, loudness, leaning forward), or open-ended (e.g., a topic of a discussion, a multi-dimensional embedding). Attention may infer something in relation to a content presentation or to an object in the content presentation. On the other hand, attention to non-content related information may correspond to a low level of engagement with a content presentation.

According to some examples, attention to be detected may be in a short list (e.g., “Wow,” “Ahh,” “Red,” “Blue,” slouching, leaning forward, left hand up, right hand up) as prescribed by any combination of the user, content, content provider, user device, etc. One will appreciate that such a short list is not required. A short list of possible reactions, if supplied by the content presentation, may arrive through a metadata stream of the content presentation.

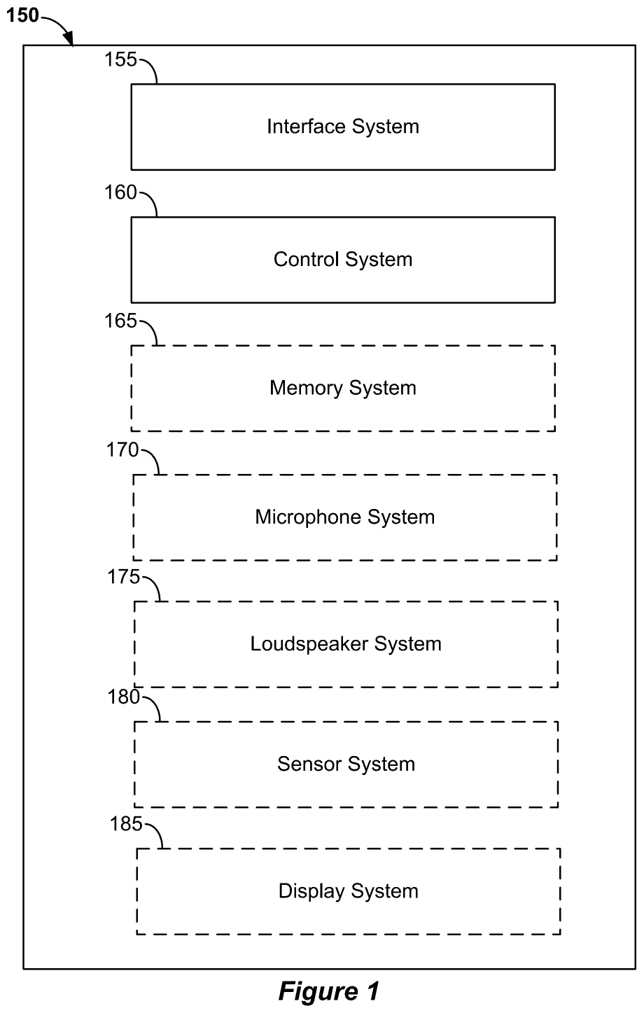

FIG. 1 is a block diagram that shows examples of components of an apparatus capable of implementing various aspects of this disclosure. As with other figures provided herein, the types, numbers and arrangements of elements shown in FIG. 1 are merely provided by way of example. Other implementations may include more, fewer and/or different types, numbers and arrangements of elements. According to some examples, the apparatus 150 may be configured for performing at least some of the methods disclosed herein. In some implementations, the apparatus 150 may be, or may include, one or more components of a workstation, one or more components of a home entertainment system, etc. For example, the apparatus 150 may be a laptop computer, a tablet device, a mobile device (such as a cellular telephone), an augmented reality (AR) wearable, a virtual reality (VR) wearable, a vehicle subsystem (e.g., an infotainment system, a driver assistance or safety system, etc.), a game system or console, a smart home hub, a head unit, such as a television or a digital media adapter (DMA), or another type of device.

According to some alternative implementations the apparatus 150 may be, or may include, a server. In some such examples, the apparatus 150 may be, or may include, an encoder. In some examples, the apparatus 150 may be, or may include, a decoder. Accordingly, in some instances the apparatus 150 may be a device that is configured for use within an environment, such as a home environment or a vehicle environment, whereas in other instances the apparatus 150 may be a device that is configured for use in “the cloud,” e.g., a server.

According to some examples, the apparatus 150 may be, or may include, an orchestrating device that is configured to provide control signals to one or more other devices. In some examples, the control signals may be provided by the orchestrating device in order to coordinate aspects of displayed video content, of audio playback, or combinations thereof. Some examples are disclosed herein.

In this example, the apparatus 150 includes an interface system 155 and a control system 160. The interface system 155 may, in some implementations, be configured for communication with one or more other devices of an environment. The environment may, in some examples, be a home environment. In other examples, the environment may be another type of environment, such as an office environment, a vehicle environment, such as an automobile, aeroplane, truck, train or bus environment, a street or sidewalk environment, a park environment, an entertainment environment (e.g., a theatre, a performance venue, a theme park, a VR experience room, an e-games arena), etc. The interface system 155 may, in some implementations, be configured for exchanging control information and associated data with other devices of the environment. The control information and associated data may, in some examples, pertain to one or more software applications that the apparatus 150 is executing.

The interface system 155 may, in some implementations, be configured for receiving, or for providing, a content stream. In some examples, the content stream may include video data and audio data corresponding to the video data. The audio data may include, but may not be limited to, audio signals. In some instances, the audio data may include spatial data, such as channel data and/or spatial metadata. Metadata may, for example, have been provided by what may be referred to herein as an “encoder.”

The interface system 155 may include one or more network interfaces and/or one or more external device interfaces (such as one or more universal serial bus (USB) interfaces). According to some implementations, the interface system 155 may include one or more wireless interfaces. The interface system 155 may include one or more devices for implementing a user interface, such as one or more microphones, one or more speakers, a display system, a touch sensor system, a gesture sensor system, or combinations thereof. Accordingly, while some such devices are represented separately in FIG. 1, such devices may, in some examples, correspond with aspects of the interface system 155.

In some examples, the interface system 155 may include one or more interfaces between the control system 160 and a memory system, such as the optional memory system 165 shown in FIG. 1. Alternatively, or additionally, the control system 160 may include a memory system in some instances. The interface system 155 may, in some implementations, be configured for receiving input from one or more microphones in an environment.

The control system 160 may, for example, include a general purpose single- or multi-chip processor, a digital signal processor (DSP), an application specific integrated circuit (ASIC), a field programmable gate array (FPGA) or other programmable logic device, discrete gate or transistor logic, discrete hardware components, or combinations thereof.

In some implementations, the control system 160 may reside in more than one device. For example, in some implementations a portion of the control system 160 may reside in a device within one of the environments referred to herein and another portion of the control system 160 may reside in a device that is outside the environment, such as a server, a game console, a mobile device (such as a smartphone or a tablet computer), etc. According to some such examples, speech recognition functionality may be provided by a device that is implementing a cloud-based service, such as a server, whereas other functionality may be provided by a local device. In other examples, a portion of the control system 160 may reside in a device within one of the environments depicted herein and another portion of the control system 160 may reside in one or more other devices of the environment. For example, control system functionality may be shared by an orchestrating device (such as what may be referred to herein as a smart home hub) and one or more other devices of the environment. In other examples, a portion of the control system 160 may reside in a device that is implementing a cloud-based service, such as a server, and another portion of the control system 160 may reside in another device that is implementing the cloud-based service, such as another server, a memory device, etc. The interface system 155 also may, in some examples, reside in more than one device.

In some implementations, the control system 160 may be configured to perform, at least in part, the methods disclosed herein. According to some examples, the control system 160 may be configured to receive, via the interface system, first sensor data from one or more sensors in a first preview environment while a content stream is being presented in the first preview environment. In some examples, the control system 160 may be configured to generate, based at least in part on the first sensor data, first user engagement data corresponding to one or more people in the first preview environment. The first user engagement data may indicate estimated engagement with presented content of the content stream. According to some examples, the control system 160 may be configured to output, via the interface system, at least some of the first user engagement data to a data aggregation device.

In some examples, the control system 160 may be configured to output, via the interface system, at least some of the first sensor data to the data aggregation device. In some such examples, a user may choose to share some, all, or none of the first sensor data with the data aggregation device, with one or more machine learning (ML) models, or both.

In some examples, the control system 160 may be configured to determine, based at least in part on user preference data, whether to provide at least some of the first user engagement data, at least some of the first sensor data, or both, to the data aggregation device, to one or more ML models, or both. According to some examples, the user preference data may specify the type(s) of sensor data from an entire preview that can be shared, may indicate one or more people whose sensor data can be shared, etc. Some examples are described below.

Some or all of the methods described herein may be performed by one or more devices according to instructions (e.g., software) stored on one or more non-transitory media. Such non-transitory media may include memory devices such as those described herein, including but not limited to random access memory (RAM) devices, read-only memory (ROM) devices, etc. The one or more non-transitory media may, for example, reside in the optional memory system 165 shown in FIG. 1 and/or in the control system 160. Accordingly, various innovative aspects of the subject matter described in this disclosure can be implemented in one or more non-transitory media having software stored thereon. The software may, for example, include instructions for controlling at least one device to perform some or all of the methods disclosed herein. The software may, for example, be executable by one or more components of a control system such as the control system 160 of FIG. 1.

In some examples, the apparatus 150 may include the optional microphone system 170 shown in FIG. 1. The optional microphone system 170 may include one or more microphones. According to some examples, the optional microphone system 170 may include an array of microphones. In some examples, the array of microphones may be configured to determine direction of arrival (DOA) and/or time of arrival (TOA) information, e.g., according to instructions from the control system 160. The array of microphones may, in some instances, be configured for receive-side beamforming, e.g., according to instructions from the control system 160. In some implementations, one or more of the microphones may be part of, or associated with, another device, such as a speaker of the speaker system, a smart audio device, etc. In some examples, the apparatus 150 may not include a microphone system 170. However, in some such implementations the apparatus 150 may nonetheless be configured to receive microphone data for one or more microphones in an environment via the interface system 160. In some such implementations, a cloud-based implementation of the apparatus 150 may be configured to receive microphone data, or data corresponding to the microphone data, from one or more microphones in an environment via the interface system 160.

According to some implementations, the apparatus 150 may include the optional loudspeaker system 175 shown in FIG. 1. The optional loudspeaker system 175 may include one or more loudspeakers, which also may be referred to herein as “speakers” or, more generally, as “audio reproduction transducers.” In some examples (e.g., cloud-based implementations), the apparatus 150 may not include a loudspeaker system 175.

In some implementations, the apparatus 150 may include the optional sensor system 180 shown in FIG. 1. The optional sensor system 180 may include one or more touch sensors, gesture sensors, motion detectors, cameras, eye tracking devices, galvanic skin response sensors, or combinations thereof. In some implementations, the one or more cameras may include one or more free-standing cameras. In some examples, one or more cameras, eye trackers, etc., of the optional sensor system 180 may reside in a television, a mobile phone, a smart speaker, a laptop, a game console or system, or combinations thereof. In some examples, the apparatus 150 may not include a sensor system 180. However, in some such implementations the apparatus 150 may nonetheless be configured to receive sensor data for one or more sensors (such as cameras, eye trackers, camera-equipped monitors, etc.) residing in or on other devices in an environment via the interface system 160. Although the microphone system 170 and the sensor system 180 are shown as separate components in FIG. 1, the microphone system 170 may be referred to, and may be considered as part of, the sensor system 180.

In some implementations, the apparatus 150 may include the optional display system 185 shown in FIG. 1. The optional display system 185 may include one or more displays, such as one or more light-emitting diode (LED) displays. In some instances, the optional display system 185 may include one or more organic light-emitting diode (OLED) displays. In some examples, the optional display system 185 may include one or more displays of a television, a laptop, a mobile device, a smart audio device, an automotive subsystem (e.g., infotainment system, driver assistance or safety system, etc.), or another type of device. In some examples wherein the apparatus 150 includes the display system 185, the sensor system 180 may include a touch sensor system and/or a gesture sensor system proximate one or more displays of the display system 185. According to some such implementations, the control system 160 may be configured for controlling the display system 185 to present one or more graphical user interfaces (GUIs).

According to some such examples the apparatus 150 may be, or may include, a smart audio device, such as a smart speaker. In some such implementations the apparatus 150 may be, or may include, a wakeword detector. For example, the apparatus 150 may be configured to implement (at least in part) a virtual assistant.

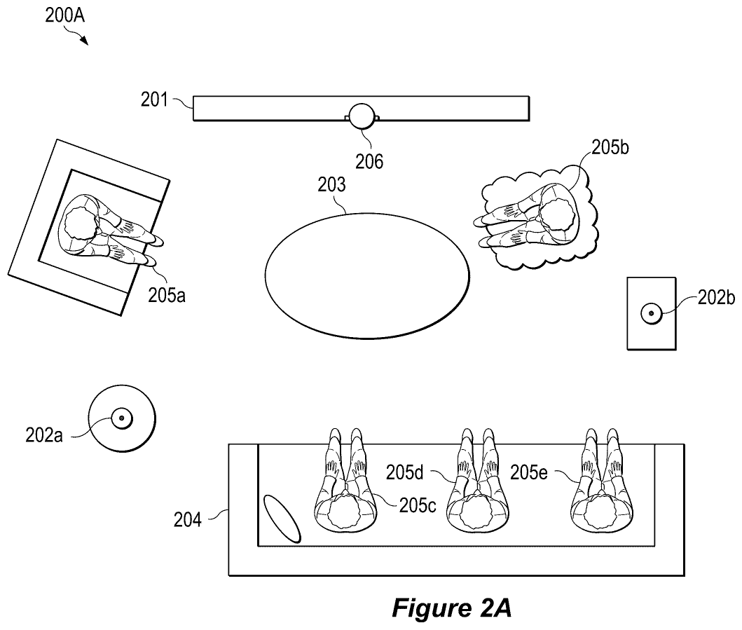

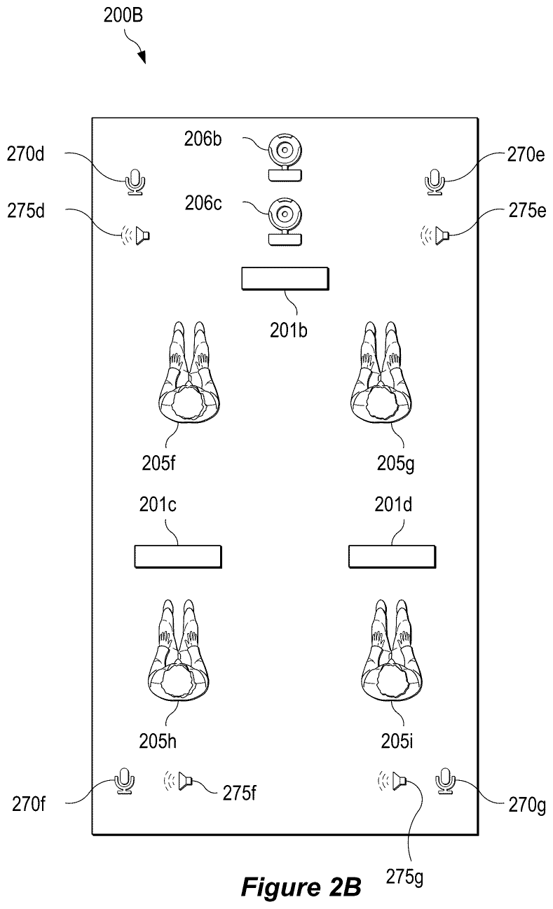

FIG. 2A shows an environment that includes examples of components capable of implementing various aspects of this disclosure. As with other figures provided herein, the types, numbers and arrangements of elements shown in FIG. 2A are merely provided by way of example. Other implementations may include more, fewer and/or different types, numbers and arrangements of elements. For example, some alternative implementations may include a multi-channel microphone puck on a table placed in front of the viewers—for example on the table 203—connected to head unit 201. In some such implementations, the camera 206 may be a web camera that is also connected to head unit 201.

In this example, the environment 200A includes a head unit 201, which is a television (TV) in this example. In some implementations, the head unit 201 may be, or may include, a digital media adapter (DMA) such as an Apple TV™ DMA, an Amazon Fire™ DMA or a Roku™ DMA. According to this example, a content presentation being provided via the head unit 201 and a loudspeaker system that includes loudspeakers of the TV and the satellite speakers 202a and 202b. In this example, the attention levels of one or more of persons 205a, 205b, 205c, 205d and 205e are being detected using a combination of one or more of camera 206 on the TV, microphones of the satellite speakers 202a and 202b, by microphones of the smart couch 204, and microphones of the smart table 203.

In this example, the sensors of the environment 200A are primarily used for detecting auditory feedback and visual feedback that may be detected by the camera 206. However, in alternative implementations the sensors of the environment 200A may include additional types of sensors, such as one or more additional cameras, an eye tracker configured to collect gaze and pupil size information, one or more ambient light sensors, one or more heat sensors, one or more sensors configured to measure galvanic skin response, etc. According to some implementations, one or more cameras in the environment 200A—which may include the camera 206—may be configured for eye tracker functionality.

The elements of FIG. 2A include:
201: A head unit 201, which is a TV in this example, providing an audiovisual content presentation and detecting user attention with microphones;
202a, 202b: Plurality of satellite speakers playing back content and detecting attention with microphone arrays;
203: A smart table detecting attention with a microphone array;
204: A smart couch detecting attention with a microphone array;
205a, 205b, 205c, 205d, 205e: Plurality of users attending to content in the environment 200A; and
206: A camera mounted on the head unit 201.

FIG. 2B shows another environment that includes examples of components capable of implementing various aspects of this disclosure. As with other figures provided herein, the types, numbers and arrangements of elements shown in FIG. 2B are merely provided by way of example. Other implementations may include more, fewer and/or different types, numbers and arrangements of elements.

In this example, FIG. 2B illustrates a scenario in which an Attention Tracking System (ATS) is implemented in a vehicle setting. Accordingly, the environment 200B is an automotive environment in this example. The back seat passengers 205h and 205i are attending to content on their respective displays 201c and 201d. The front seat users 205f and 205g are attending to the drive, attending to a display 201b, and attending to audio content playing out of the loudspeakers. The audio content may include music, a podcast, navigational directions, etc. An ATS is leveraging the sensors in the car (e.g., a subset of sensors in the vehicle) to determine each user's degree of attention to content.

The elements of FIG. 2B include:
201b: The main display screen in the car with satnav, reverse camera, music controls, etc.;
201c, 201d: Passenger screens designed to play entertainment content such as movies;
205f, 205g, 205h, 205i: Plurality of users attending to content in the vehicle;
206b: Camera facing the outside of the vehicle detecting content such as billboards;
206c: Camera facing the interior of the vehicle detecting user attention;
270d, 270e, 270f, 270g: Plurality of microphones picking up noises in the vehicle, including content playback, audio indications of user attention, etc.; and
275d, 275e, 275f, 275g: Plurality of speakers playing back content.

According to some examples, one or more devices may implement what is referred to herein as a Device Analytics Engine (DAE). DAEs are configured to detect user activity from sensor signals. There may be different implementations of a DAE, in some instances even within the same Attention Tracking System. The particular implementation of the DAE may, for example, depend on the sensor type or mode. For example, some implementations of the DAE may be configured to detect user activity from microphone signals, whereas other implementations of the DAE may be configured to detect user activity, attention, etc., based on camera signals. Some DAEs may be multimodal, receiving and interpreting inputs from different sensor types. In some examples, DAEs may share sensor inputs with other DAEs. Outputs of DAEs also may vary according to the particular implementation. DAE output may, for example, include detected phonemes, emotion type estimations, heart rate, body pose, a latent space representation of sensor signals, etc.

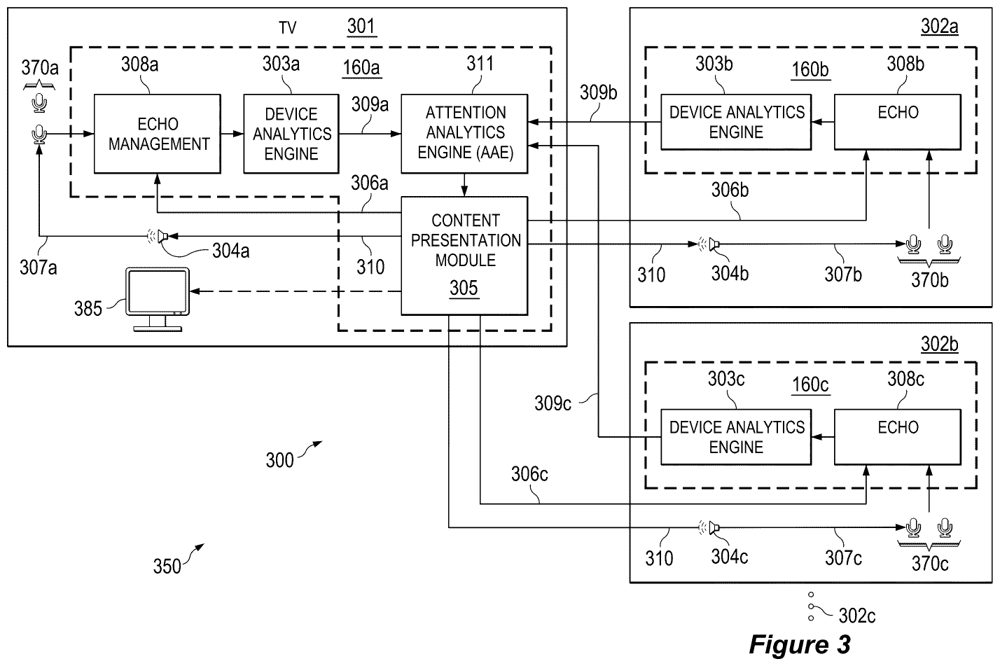

In some examples, one or more devices may implement what is referred to herein as an Attention Analytics Engine (AAE), which analyses user attention information in reference to the current content, by taking data from a sensor system 180 or, in some implementations, results from one or more DAEs, which are produced using measurements from sensors. Examples of AAEs and DAEs are described below with reference to FIGS. 3-5. According to some examples, an AAE, a DAE, or both, may be configured to produce what is referred to herein as “user attention data” or “user engagement data.”

FIG. 3 shows components of an Attention Tracking System (ATS) residing in a playback environment according to one example. As with other figures provided herein, the types, numbers and arrangements of elements shown in FIG. 3 are merely provided by way of example. Other implementations may include more, fewer and/or different types, numbers and arrangements of elements.

In the example of FIG. 3, the ATS 350 includes an Attention Analytics Engine (AAE) 311 and a content presentation module 305 residing in a head unit 301, which is a television (TV) in this example. A plurality of sensors, which include microphones 370a of the head unit 301, microphones 370b of the satellite speaker 302a and microphones 370c of the satellite speaker 302b, provide sensor data to the AAE 311 corresponding to what is occurring in the environment 300. Other implementations may include additional types of sensors, such as one or more cameras, one or more eye trackers configured to collect gaze and pupil size information, one or more ambient light sensors, one or more heat sensors, one or more sensors configured to measure galvanic skin response, etc. As suggested by the dots and element number 302c, some implementations may include three or more satellite speakers.

The microphones 370a-370c will detect audio of a content presentation. In this example, echo management modules 308a, 308b and 308c are configured to suppress audio of the content presentation, allowing more reliable detection of sounds corresponding to the users' reactions over the content in the signals from the microphones 370a-370c. In this example, the content presentation module 305 is configured to send echo reference information 306 to the echo management modules 308a, 308b and 308c. The echo reference information 306 may, for example, contain information about the audio being played back by the loudspeakers 304a, 304b and 304c. As a simple example, local echo paths 307a, 307b and 307c may be cancelled using a local echo reference with a local echo canceller. However, any type of echo management system could be used here, such as a distributed acoustic echo canceller.

According to the examples shown in FIG. 3, the head unit 301 includes Device Analytics Engine (DAE) 303a, the satellite speaker 302a includes DAE 303b and the satellite speaker 302b includes DAE 303c. Here, the DAEs 303a, 303b and 303c are configured to detect user activity from sensor signals, which are microphone signals in these examples. There may be different implementations of the DAE 303, in some instances even within the same Attention Tracking System. The particular implementation of the DAE 303 may, for example, depend on the sensor type or mode. For example, some implementations of the DAE 303 may be configured to detect user activity from microphone signals, whereas other implementations of the DAE 303 may be configured to detect user activity, attention, etc., based on camera signals. Some DAEs may be multimodal, receiving and interpreting inputs from different sensor types. In some examples, DAEs may share sensor inputs with other DAEs. Outputs of DAEs 303 also may vary according to the particular implementation. DAE output may, for example, include detected phonemes, emotion type estimations, heart rate, body pose, a latent space representation of sensor signals, etc.

In the implementation shown in FIG. 3, the outputs 309a, 309b and 309c from the DAEs 303a, 303b and 303c, respectively, are fed into the AAE 311. Here, the AAE 311 is configured to combine the information of the DAEs 303a-303c to produce attention analytics. The AAE 311 may be configured to use various types of data distillation techniques, such as neural networks, algorithms, etc. For example, an AAE 311 may be configured to use natural language processing (NLP) using speech recognition output from one or more DAEs. In this example, the analytics produced by AAE 311 allow for real-time adjustments of content presentations by the content presentation module 305. The content presentation 310 is then provided to, and played out of, actuators that include the loudspeakers 304a, 304b and 304c, and the TV display screen 385 in this example. Other examples of actuators that could be used include lights and haptic feedback devices.

The elements of FIG. 3 include:
308a, 308b, 308c: Echo management modules configured to reduce the level of the content playback that is picked up in the microphones;
303a, 303b, 303c: Device analytics engines, which are configured to convert sensor readings into the probability of certain attention events, such as laughter, gasping or cheering, and to provide input to the AAE 311;
304a, 304b, 304c: The loudspeakers in each device playing back the audio from the content presentation module 305;
306a, 306b, 306c: Echo reference information;
307a, 307b, 307c: The echo paths between a duplex device's plurality of speakers to its plurality of microphones.
311: An AAE, which in this example is configured to produce what is referred to herein as “user attention data” or “user engagement data” based on input from the DAEs 303a, 303b and 303c;
370a, 370b, 370c: Microphones picking up sounds in the environment 300, including content playback, audio corresponding to user responses, etc.; and
385: A TV display configured for displaying content from the content presentation module 305.

In these examples, the AAE 311, the content presentation module 305, the echo management module 308a and the DAE 303a are implemented by an instance 160a of the control system 160 of FIG. 1, the echo management module 308b and the DAE 303b are implemented by another instance 160b of the control system 160 and the echo management module 308c and the DAE 303c are implemented by a third instance 160c of the control system 160. In some examples, the AAE 311, the content presentation module 305, the echo management modules 308a-308c and the DAEs 303a-303c may be implemented as instructions, such as software, stored on one or more non-transitory and computer-readable media.

### Acoustic Event Detection

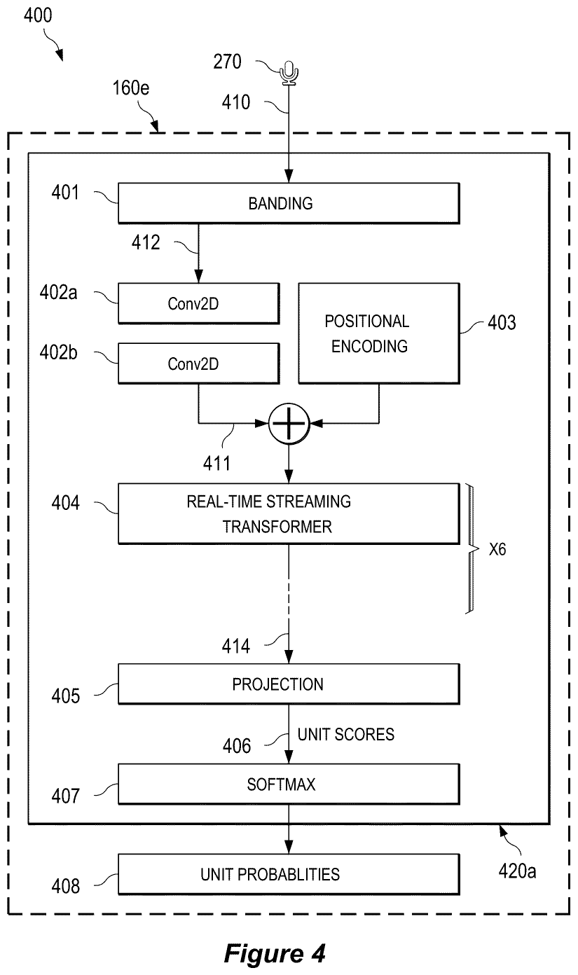

FIG. 4 shows components of a neural network capable of performing real-time acoustic event detection according to one example. As with other figures provided herein, the types, numbers and arrangements of elements shown in FIG. 4 are merely provided by way of example. Other implementations may include more, fewer and/or different types, numbers and arrangements of elements.

FIG. 4 shows example components of a neural network 400 that is capable of implementing a Device Analytics Engine 420 for a microphone 270. In this example, the neural network 400 is implemented by control system instance 160e. According to this example, microphone signals 410 from the microphone 270 are passed into the banding block 401 to create a time-frequency representation of the audio in the microphone signals 410. The resulting frequency bands 412 are passed into two-dimensional convolutional layers 402a and 402b, which are configured for feature extraction and down-sampling, respectively. In this example, a positional encoding 403 is stacked onto the features 411 output by the convolutional layers 402a and 402b, so the real-time streaming transformers 404 can consider temporal information. The embeddings 414 produced by the transformers are projected—using a fully connected layer 405—into the number of desired unit scores 406. The unit scores may represent anything related to acoustic events, such as subword units, phonemes, laughter, cheering, gasping, etc. According to this example, a SoftMax module 407 is configured to normalize the unit scores 406 into unit probabilities 408 representing the posterior probabilities of acoustic events. The unit probabilities 408 are examples of what may be referred to herein as “user attention data” or “user engagement data.” In other examples, the unit probabilities 408 may be input to an AAE and the AAE may be configured to output user attention data or user engagement data.

Other examples of attention-related acoustic events that could be detected for use in the proposed techniques and systems include:
Sounds that could possibly indicate being engaged: laughing, screams, cheering, booing, crying, sniffling, groans, vocalizations of ooo, ahh and shh, talking about the content, cursing, etc.;
Sounds that could possibly indicate being unengaged: typing, door creaking, snoring, footsteps, vacuuming, washing dishes, chopping food, talking about something other than the content, different content playing on a device not connected to the attention system;
Sounds that could be used to indicate attention for specific content types, such as:
Movies: saying an actor's name;
Sports: naming a player or team;
When music is the content or is within the content: whistling, applause, singing along with the content, a person making a repetitive noise or gesture (e.g., foot tapping, finger snapping, nodding, etc.) corresponding with a rhythm of the content;
In children's shows: children making emotive vocalizations, or responding to a “call and response” prompt;
Workout-related content: Grunting, heavy breathing, groaning, gasping;
Other noises that may help infer attention to the content based on the context of the content: such as silence during a dramatic time interval, naming an object, character or concept in a scene, etc.

The elements of FIG. 4 include:
400: Example neural network architecture of a real-time audio event detector;
401: A banding block configured to process time-domain input into banded time-frequency domain information;
402a, 402b: Two-dimensional convolution layers;
403: Positional encoding that stacks positional information onto the features 411 output by the convolutional layers 402a and 402b;
404: A plurality (six in this example) of real-time streaming transformer layers;
405: A fully connected linear layer to act as a projection to unit scores 414 output by the real-time streaming transformer layers 404;
406: Units scores representing different audio event classes. Unit scores may represent audio events such as laughter, gasping, cheering, etc.
407: A SoftMax module 407 configured to normalize the unit scores 406 into unit probabilities 408 representing the likelihood of acoustic events;
408: The resulting unit probabilities; and
420a: A Device Analytics Engine configured to detect attention-related events in microphone input data.

### Visual Detections

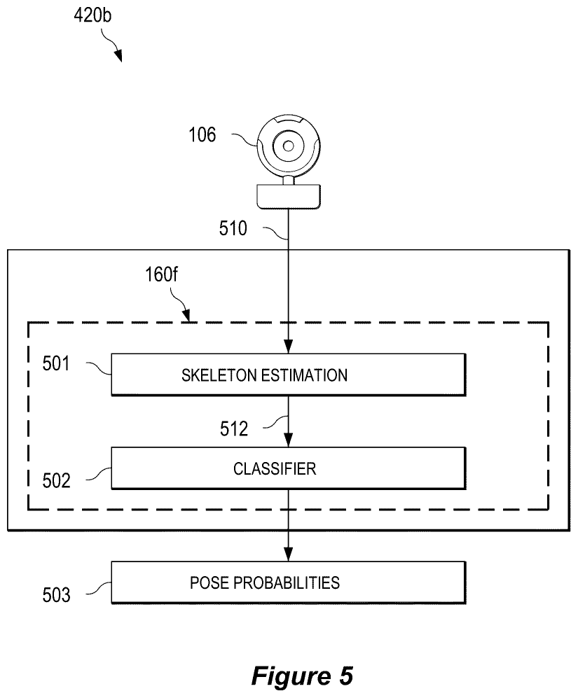

FIG. 5 shows components of a device analytics engine configured for performing real-time pose estimation according to one example. As with other figures provided herein, the types, numbers and arrangements of elements shown in FIG. 5 are merely provided by way of example. Other implementations may include more, fewer and/or different types, numbers and arrangements of elements.

FIG. 5 shows example components of a Device Analytics Engine (DAE) 420b configured to estimate user attention from visual information. In this example, the DAE 420b is implemented by control system instance 160f. The DAE 420b may be configured to estimate user attention from visual information via a range of techniques, depending on the particular implementation. Some examples involve applying machine learning methods, using algorithms implemented via software, etc.

In the example shown in FIG. 5, the DAE 420b includes a skeleton estimation module 501 and a pose classifier 502. The skeleton estimation module 501 is configured to calculate the positions of a person's primary bones from the camera data 510, which includes a video feed in this example, and to output skeletal information 512. The skeleton estimation module 501 may be implemented with publicly available toolkits such as YOLO-Pose. The pose classifier 502 may be configured to implement any suitable process for mapping skeletal information to pose probabilities, such as a gaussian mixture model or a neural network. According to this example, the DAE 420b—in this example, the pose classifier 502—is configured to the output the pose probabilities 503. The pose probabilities 503 are examples of what may be referred to herein as “user attention data” or “user engagement data.” In other examples, the pose probabilities 503 may be input to an AAE and the AAE may be configured to output user attention data or user engagement data. In some examples, the DAE 420b also may be configured to estimate the distances of one or more parts of the user's body according to the camera data.

Visual detections can reveal a range of attention information. Some examples include:
Visuals that may indicate a person being positively engaged: leaning forward, lying back, moving in response to events in the content, wearing clothes signifying allegiance to something in the content, etc.;
Visuals that may indicate a person being negatively engaged: a facial expression indicating disgust, a person's hand “flipping the bird,” etc.;
Visuals that may indicate a person being unengaged: a person is looking at a phone when the phone is not being used to provide the content presentation, the person is holding a phone to their head when the phone is not being used to provide the content presentation, the person is asleep, no person in the room is paying attention, no one is present, etc.

The elements of FIG. 5 include:
420b: A Device Analytics Engine configured to perform real-time pose estimation based on the camera data 510;
501: A skeleton estimation module configured to calculate the positions and rotations of a person's primary bones from the camera data 510 and to output skeletal information 512;
502: A pose classifier configured to map the skeletal information 512 to pose probabilities 503; and
503: The resulting pose probabilities.

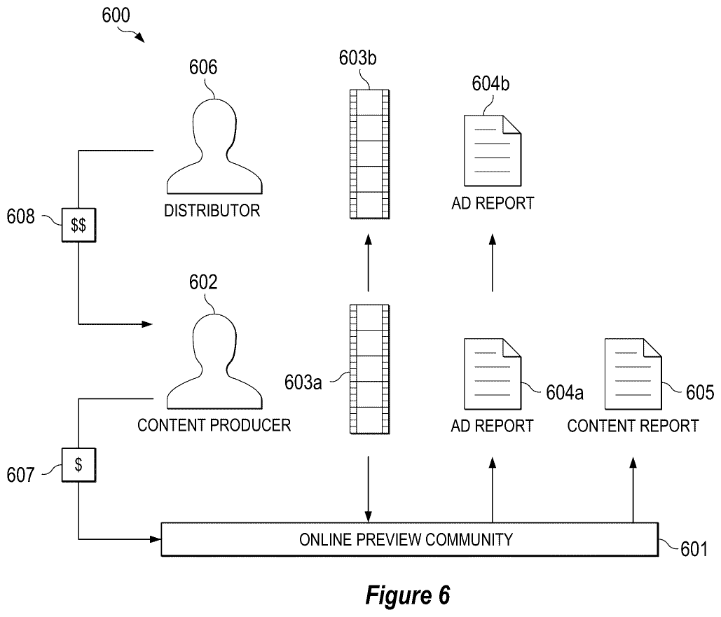

FIG. 6 shows examples of inputs and outputs of an online preview community (OPC). As with other figures provided herein, the types, numbers and arrangements of elements shown in FIG. 6 are merely provided by way of example. Other implementations may include more, fewer and/or different types, numbers and arrangements of elements.

According to this example, FIG. 6 includes the following elements:
600: a business model for the OPC 601;
601: an OPC in which content—which is generally pre-release content—is shown to participants in the OPC and reports are aggregated;
602: a content producer;
603a, 603b: content that is in possession of the content producer 602 and distributer 606 respectively;
604a, 604b: instances of an ad report containing information to inform what ads to place when in its corresponding piece of content;
605: a content report reflecting how audiences engaged with the content supplied to the OPC;
606: the content distributer;
607: money paid by the content producer 602 to the OPC 601 and/or an entity implementing the OPC 601 in exchange for showing their content on the OPC and for receiving an ad report 604 and content report 605; and
608: money paid by the content distributer 606 to the content producer 602.

According to some examples, the following steps may occur according to business model 600.

The content producer 602 creates a piece of content 603a.

The content producer 602 previews their content on the OPC 601 and pays the OPC and/or an entity implementing the OPC 601 for their services.

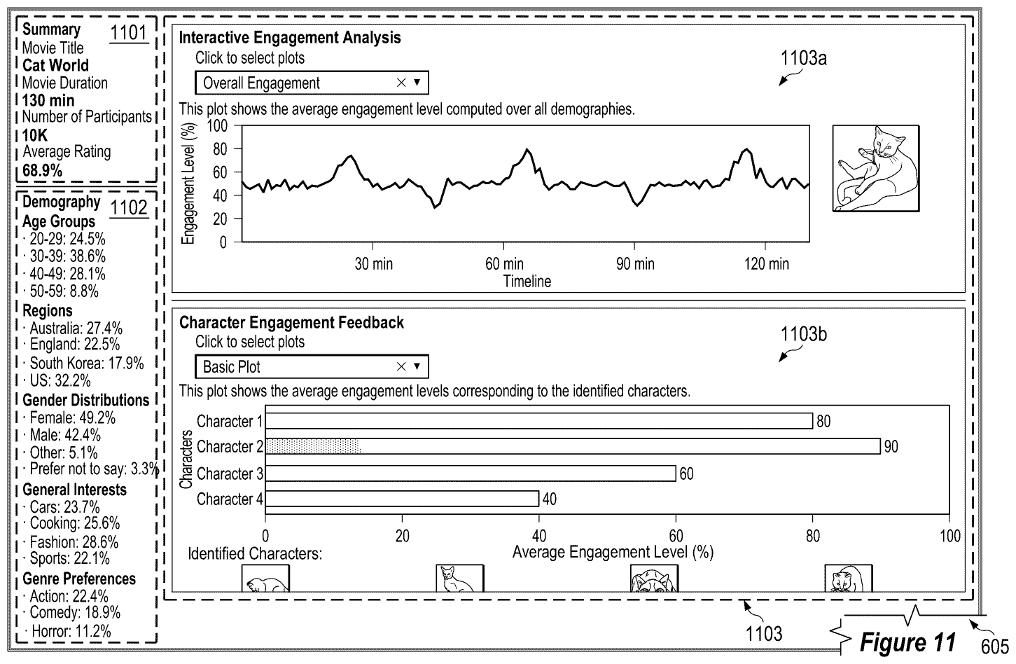

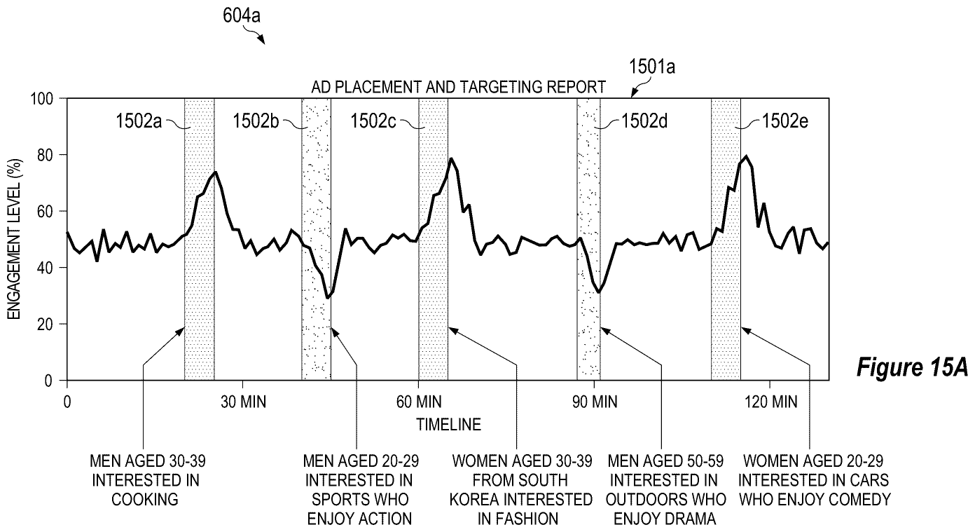

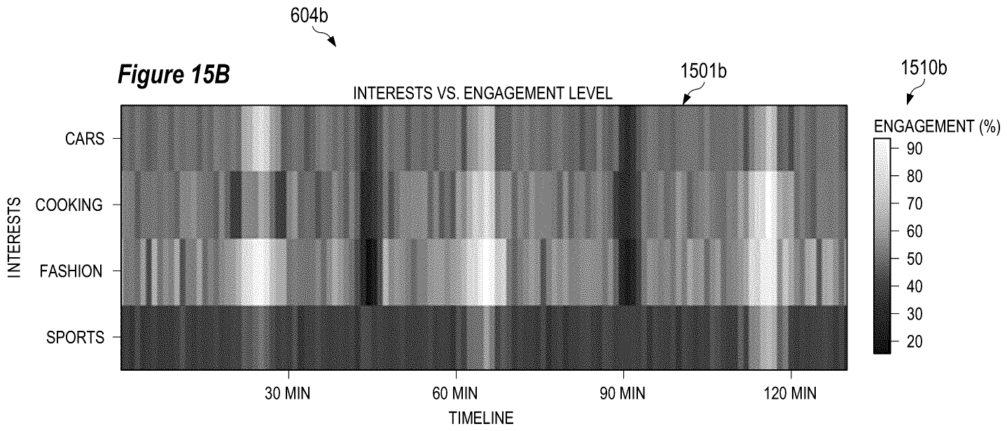

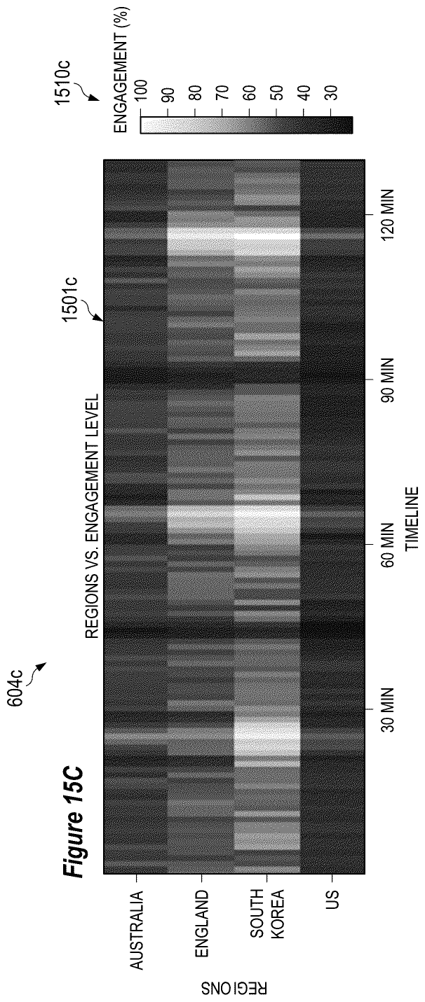

One or more devices implementing the OPC 601 return an ad report 604a and a content report 605 to the content producer 602. The ad report 604 may contain information about which audiences—for example, based on demographic information (e.g., age, location, etc.) and interest information (e.g., cars, cooking, fashion, outdoors, wine, sports, etc.)—are interested in each part of the content 603a. Examples of the ad report 604 are described herein with reference to FIGS. 15A-15C. The content report 605 may, for example, provide details regarding how the content 603a was received overall and by different audience types. The content report 605 may, in some examples, include an aggregation of survey responses from previewers. The content report 605 may, in some examples, include a wide range of information such as audience's sentiment towards each character. Examples of the content report 605 are described herein with reference to FIGS. 11 to 14.

The content producer 602 may use the content report 605 to inform alterations to the content 603a and perform one or more additional iterations of previewing, for example by paying the OPC 601 and/or an entity implementing the OPC 601 for another report on the updated content. The content producer 602 may also use the content report 605 to inform future content, for example, knowing which character to give extra screentime based on the audience's sentiment toward the character.

The content producer 602 supplies a distributer of content 606 with their content 603b and optionally the corresponding ad report 604b. The distributer 606 may achieve more effective ad placement using the ad report 604b, possibly leading to greater revenue for the distributer. The content producer receives payment from the distributer 607.

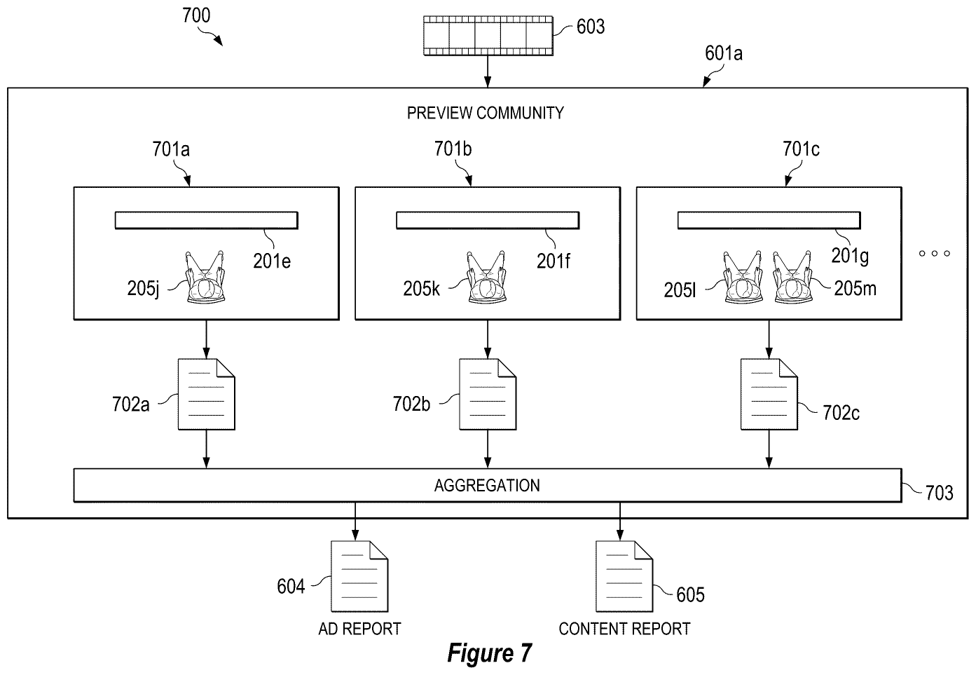

FIG. 7 shows examples of OPC elements. As with other figures provided herein, the types, numbers and arrangements of elements shown in FIG. 7 are merely provided by way of example. Other implementations may include more, fewer and/or different types, numbers and arrangements of elements. For example, while FIG. 7 shows three preview environments, some OPC implementations may include more than three preview environments, in some cases many more than three preview environments (e.g., tens, hundreds or thousands of preview environments). The possibility of additional preview environments is suggested by the three dots adjacent to the preview environment 701c.

According to this example, FIG. 7 includes the following elements:
201e, 201f and 201g: head units, which are televisions (TVs) in these examples;
205j, 205k, 205l and 205m: people in the preview environments who have agreed to participate in the OPC, who may be referred to as “OPC previewers”;
601a: an instance of the OPC 601 shown in FIG. 6;
603: content being streamed to the TVs 201e, 201f and 201g;
604: an ad report;
605: a content report;
700: a schematic diagram of how the OPC 601a operates;
701a: a preview environment (household, vehicle, etc.) in which OPC previewer 205j is consuming content 603, which is pre-release content in this example, via the head unit 201e;
701b: a preview environment in which OPC previewer 205k is consuming the content 603 via the head unit 201f;
701c: a preview environment in which OPC previewers 205l and 205m are consuming the content 603 via the head unit 201g;
702a, 702b and 702c: user engagement data from preview environments 701a, 701b and 701c, respectively, containing information corresponding to sensor data received from OPC previewers' devices; and
703: An aggregator, including one or more devices configured to aggregate user engagement data 702a, 702b and 702c into the ad report 604 and the content report 605. According to some examples, the aggregator 703 may be configured to calculate the mean and variance of different forms of user engagement—for instance, excited, sad, etc.—across all of the viewers of a piece of content. More complex implementations of the aggregator 703 may be configured to implement one or more neural networks. The one or more neural networks may be configured to, e.g., find the T (e.g., 4, 5, 6, 7, 8, etc.) most common types of survey response to the content given all the responses supplied by the OPC participants, as determined by clustering large language model (LLM) embeddings. In some implementations, the aggregator 703 may be configured to implement a LLM configured to write a survey response for each of the clustered common survey response types as representative responses.

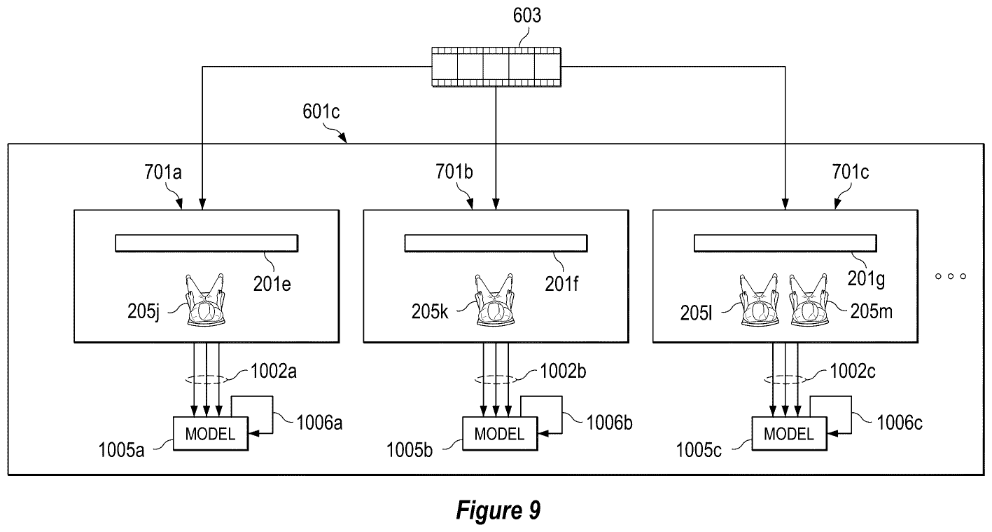

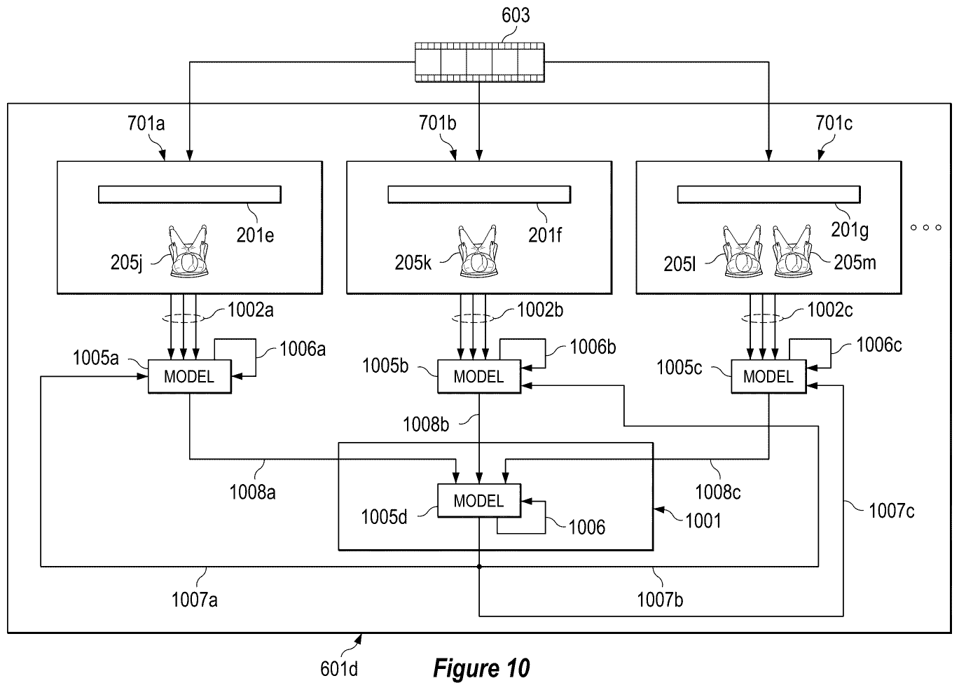

In this example, a device or system corresponding to, and which may be located in, each of the preview environments 701a-701c is configured to generate user engagement data corresponding to that preview environment. According to some examples, the device or system may be, or may include, an instance of the apparatus 150 of FIG. 1. For example, instances of the control system 160 may be configured to generate the user engagement data 702a-702c, for example by implementing instances of an Attention Tracking System (ATS), including one or more Device Analytics Engines (DAEs) and one or more Attention Analytics Engines (AAEs). According to some examples, at least some of the user engagement data 702a-702c may correspond to the output of the AAE 311 of FIG. 3, the unit probabilities 408 of FIG. 4 or the pose probabilities 503 of FIG. 5. In some examples, the head units 201e, 201f and 201g may be configured to generate the user engagement data 702a-702c. For example, the head units 201e, 201f and 201g may be configured to implement what is referred to herein as a local machine learning (ML) model, such as the local ML models 1005a, 1005b and 1005c that are described with reference to FIG. 9 or FIG. 10. In some such examples, each of the local ML models may be configured to implement one or more DAEs that are configured to generate the user engagement data 702a-702c. In other examples, each of the local ML models may be configured to implement an AAE that is configured to generate the user engagement data 702a-702c. In other examples, another device—not shown in FIG. 7—may be configured to generate the user engagement data 702a-702c. The user engagement data 702a-702c indicate how one or more of the engaged with the content supplied to the OPC.

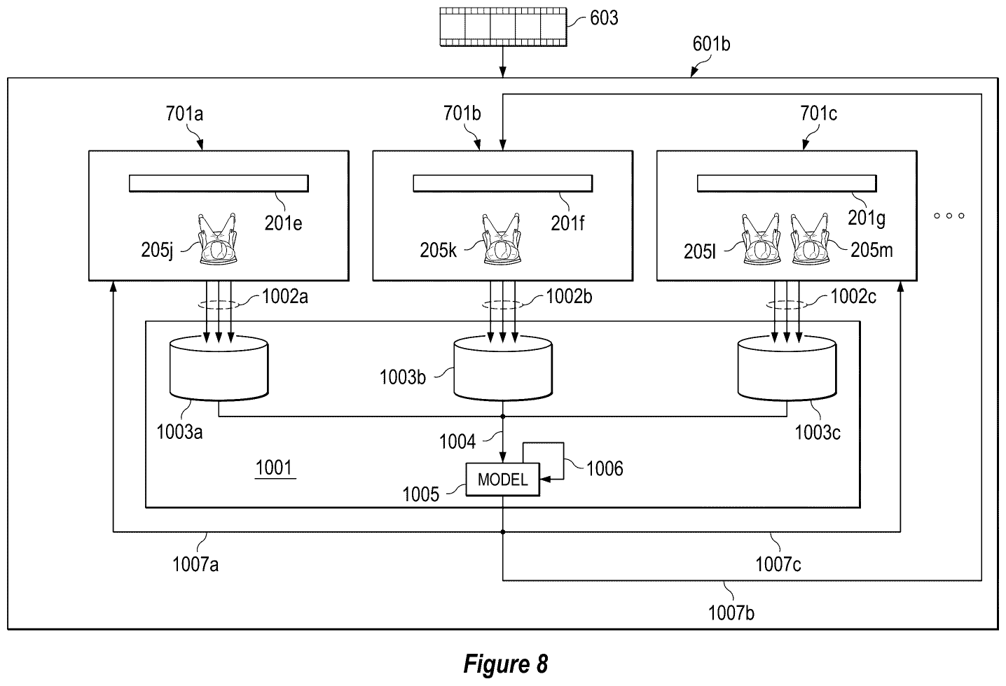

FIG. 8 shows additional examples of OPC elements. As with other figures provided herein, the types, numbers and arrangements of elements shown in FIG. 8 are merely provided by way of example. Other implementations may include more, fewer and/or different types, numbers and arrangements of elements.

According to this example, FIG. 8 includes the following elements:
201e, 201f and 201g: head units, which are televisions (TVs) in these examples;
205j, 205k, 205l and 205m: OPC previewers;
601b: an instance of the OPC 601 shown in FIG. 6;
701a: a preview environment (household, vehicle, etc.) in which OPC previewer 205j is consuming content 603, which is pre-release content in this example, via the head unit 201e;
701b: a preview environment in which OPC previewer 205k is consuming the content 603 via the head unit 201f;
701c: a preview environment in which OPC previewers 205l and 205m are consuming the content 603 via the head unit 201g;
1001: the infrastructure hosting the OPC, which may include one or more servers, one or more storage devices, etc.;
1002a, 1002b and 1002c: data flowing from devices in their respective preview environments 701a, 701b and 701c, respectively, to the OPC infrastructure 1001. The data 1002a, 1002b and 1002c may include user engagement data, sensor data (for example, audio data, video data, galvanic skin response signals, etc.), or both;
1003a, 1003b, 1003c: stored data from the preview environments 701a, 701b and 701c, respectively;
1004: data input to the federated machine learning (ML) model 1005;
1005: a federated ML model that is configured to be trained based, at least in part, on user engagement data from a plurality of preview environments, sensor data from a plurality of preview environments, or both;
1006: updates to the federated ML model 1005 during a training process; and
1007a, 1007b and 1007c: updated federated ML model data sent to devices—such as the head units 201e, 201f and 201g—in the preview environments 701a, 701b and 701c, respectively. The updates 1006 and updated federated ML model data 1007a, 1007b and 1007c may, for example, include updated weights for neural network nodes, gradients of at least a subset of neural network parameters, updates to a subset of a neural network's parameters, or combinations thereof.

Although not shown in FIG. 8, in some examples a device in each of the preview environments 701a, 701b and 701c may be configured to implement a local ML model that may be updated according to the updated federated ML model data. The updates 1006 and updated federated ML model data 1007a, 1007b and 1007c may, for example, include learnings about ways to better determine user engagement. For example, learnings of a local ML model of a preview environment may indicate how to better differentiate between a person and their couch. After this local learning is aggregated on the federated ML model 1005 and redistributed to other local models, the local models of one or more other stations may benefit from these learnings if the corresponding preview environments have a similar couch. In some such examples, the local ML models may not be trained according to sensor data, engagement data, etc., obtained at the same preview environment, but may nonetheless be updated according to the updated federated ML model data. In some alternative examples, there may not be local ML models in one or more of the preview environments 701a, 701b and 701c and there may be no updated federated ML model data sent to one or more of the preview environments.

As noted above, the data 1002a, 1002b and 1002c may include user engagement data, sensor data, or both. According to some examples, the data 1002a, 1002b and 1002c may include time data, such as time stamps, corresponding to time data of the content 603. For example, a time stamp for one portion of the data 1002a may include a time stamp of 23 minutes, 15 seconds, indicating that the portion of the data 1002a corresponds with the 23rd minute and 15th second of the content 603.

According to some examples, devices in the preview environments 701a, 701b and 701c may be configured to determine, for example based on user preference data, whether to provide at least some of the first user engagement data, at least some of the first sensor data, or both, to the OPC infrastructure 1001. In some examples, devices in the preview environments 701a, 701b and 701c—such as the head units 201e, 201f and 201g—may be configured to determine, for example based on user preference data, whether to provide at least some of the first user engagement data, at least some of the first sensor data, or both, to—or for use by—one or more ML models.

In some examples, the OPC previewers 205j, 205k, 205l and 205m may provide user preference data to a device in each of the respective preview environments 701a, 701b and 701c indicating whether or not to share any type of sensor data with the OPC infrastructure 1001, whether or not to share any type of sensor data with one or more ML models, or both. In some instances, a user may choose not to share any “raw” sensor data at all, but may choose to share user engagement data that has been locally derived from such sensor data. According to some examples, the user preference data may indicate that only one or more selected types of sensor data—such as only microphone data—may be shared with the OPC infrastructure 1001, or may be used by one or more ML models, or both.

In some instances, there may be a minimum requirement for sharing sensor data in order to become an OPC previewer. For example, in order to become an OPC previewer, at least microphone data from a preview environment may need to be shared.

According to some examples, the user preference data may indicate preferences on a per-preview-environment basis. For example, user preference data may be received by a device of the preview environment 701c indicating that camera data corresponding to anyone in the preview environment 701c may be shared with the OPC infrastructure 1001, or may be used by one or more ML models, or both. In other examples, the user preference data may indicate preferences on a per-person basis. For example, user preference data may be received by a device of the preview environment 701c indicating that camera data corresponding to the OPC previewer 205l may be shared with the OPC infrastructure 1001, or may be used by one or more ML models, or both, but that camera data corresponding to the OPC previewer 205m may not be shared with the OPC infrastructure 1001 or used by one or more ML models.

In some examples, the data 1004 that is input to the federated machine learning ML model 1005 is, or includes, unlabelled data. In some such examples, the federated ML model 1005 is an unsupervised ML model, which also may be referred to as a self-supervised ML model, that is allowed to discover patterns without any explicit guidance or instruction.

According to some examples, the federated ML model 1005 may be a weakly supervised ML model. For example, the data 1004 that is input to the federated machine learning ML model 1005 may include some explicit engagement information, such as one or more explicit ratings from one or more OPC previewers. The explicit rating(s) may pertain to an entire piece of content—such as an entire movie—or to one or more portions of content, such as one or more particular scenes.

In some examples, the OPC 601b may solicit explicit engagement information, for example with reference to one or more portions of content. In one such example, the OPC 601b may show an image, e.g., on a TV used by an OPC previewer, of the OPC previewer's face while the OPC previewer was viewing a particular scene. In some such examples, the OPC previewer's face may be displayed in a window overlaying an image from the scene. The OPC 601b may solicit feedback for clarification of the OPC previewer's engagement with an audio or textual prompt, for example, “I couldn't tell from your expression whether you liked this scene. Did you?Please say “yes” or “no.””

Although not expressly shown in FIG. 8, the OPC 601b may be configured to prepare and output an ad report 604, a content report 605, or both. In some examples, the OPC 601b may be configured to generate the ad report 604 and the content report 605 based on the output of the federated machine learning ML model 1005.

FIG. 9 shows additional examples of OPC elements. As with other figures provided herein, the types, numbers and arrangements of elements shown in FIG. 9 are merely provided by way of example. Other implementations may include more, fewer and/or different types, numbers and arrangements of elements.

According to this example, FIG. 9 includes the following elements:
201e, 201f and 201g: head units, which are televisions (TVs) in these examples;
205j, 205k, 205l and 205m: OPC previewers;
601c: an instance of the OPC 601 shown in FIG. 6;
701a: a preview environment (household, vehicle, etc.) in which OPC previewer 205j is consuming content 603, which is pre-release content in this example, via the head unit 201e;
701b: a preview environment in which OPC previewer 205k is consuming the content 603 via the head unit 201f;
701c: a preview environment in which OPC previewers 205l and 205m are consuming the content 603 via the head unit 201g;
1002a, 1002b and 1002c: data flowing from devices in their respective preview environments 701a, 701b and 701c, respectively, to the local ML models 1005a, 1005b and 1005c. The data 1002a, 1002b and 1002c may include user engagement data, sensor data (for example, audio data, video data, galvanic skin response signals, etc.), or both;
1005a, 1005b and 1005c: local ML models that are configured to be trained based on sensor data from an individual preview environment, user engagement data from an individual preview environment, or both; and
1006a, 1006b and 1006c: updates to the local ML models 1005a, 1005b and 1005c during training processes.

The local ML models 1005a, 1005b and 1005c may each be implemented by an instance of the apparatus 150 of FIG. 1. In some examples, the local ML models 1005a, 1005b and 1005c may each be implemented by an instance of the apparatus 150 that resides in the preview environments 701a, 701b and 701c. According to some alternative examples, the local ML models 1005a, 1005b and 1005c may each be implemented by an instance of the apparatus 150 that resides elsewhere, such as a server provided by a cloud-based service, even though the local ML models 1005a, 1005b and 1005c are configured to be trained based on sensor data from an individual preview environment.

As noted above, the data 1002a, 1002b and 1002c may include user engagement data, sensor data, or both. According to some examples, the data 1002a, 1002b and 1002c may include time data, such as time stamps, corresponding to time data of the content 603.

According to some examples, devices in the preview environments 701a, 701b and 701c may be configured to determine, for example based on user preference data, selected user engagement data, selected sensor data, or both, to provide to the local ML models 1005a, 1005b and 1005c. In some examples, the user preference data may indicate that only one or more selected types of sensor data—such as only microphone data—may be provided to a local ML model. According to some examples, the user preference data may indicate preferences on a per-preview-environment basis or on a per-person basis. In some instances, there may be a minimum requirement for sharing sensor data in order to become an OPC previewer. For example, in order to become an OPC previewer, at least microphone data from a preview environment may need to be shared.

In some examples, the data 1004 that is input to one or more of the local ML models 1005a, 1005b and 1005c may be, or may include, unlabelled data. In some such examples, one or more of the local ML models 1005a, 1005b and 1005c may be an unsupervised ML model, which also may be referred to as a self-supervised ML model. According to some examples, one or more of the local ML models 1005a, 1005b and 1005c may be a weakly supervised ML model. In some examples, the OPC 601c may solicit explicit engagement information, for example with reference to one or more portions of content.

Although not expressly shown in FIG. 9, the OPC 601c may be configured to prepare and output an ad report 604, a content report 605, or both. In some examples, the OPC 601c may include an instance of the aggregator 703 of FIG. 7 that is configured to aggregate output of the local ML models 1005a, 1005b and 1005c into the ad report 604 and the content report 605.

FIG. 10 shows additional examples of OPC elements. As with other figures provided herein, the types, numbers and arrangements of elements shown in FIG. 10 are merely provided by way of example. Other implementations may include more, fewer and/or different types, numbers and arrangements of elements.

According to this example, FIG. 10 includes the following elements:
201e, 201f and 201g: head units, which are televisions (TVs) in these examples;
205j, 205k, 205l and 205m: OPC previewers;
601d: an instance of the OPC 601 shown in FIG. 6;
701a: a preview environment (household, vehicle, etc.) in which OPC previewer 205j is consuming content 603, which is pre-release content in this example, via the head unit 201e;
701b: a preview environment in which OPC previewer 205k is consuming the content 603 via the head unit 201f;
701c: a preview environment in which OPC previewers 205l and 205m are consuming the content 603 via the head unit 201g;
1002a, 1002b and 1002c: data flowing from devices in their respective preview environments 701a, 701b and 701c, respectively, to the local ML models 1005a, 1005b and 1005c. The data 1002a, 1002b and 1002c may include user engagement data, sensor data (for example, audio data, video data, galvanic skin response signals, etc.), or both;
1005a, 1005b and 1005c: local ML models that are configured to be trained based on sensor data from an individual preview environment, user engagement data from an individual preview environment, or both;
1005d: a federated ML model that is configured to be trained based, at least in part, on updated local ML model data 1008a, 1008b and 1008c from the local ML models 1005a, 1005b and 1005c, respectively. For example, the updated local ML model data 1008a, 1008b and 1008c may be, or may include, the weights and/or gradients of the local ML models 1005a, 1005b and 1005c after many local iterations of training. The federated ML model may be configured to be trained based, at least in part, on updated local ML model data 1008a, 1008b and 1008c according to any suitable federated learning process or algorithm, such as a federated averaging (FedAvg) process, a federated learning process with buffered asynchronous aggregation (FedBuff), or combinations thereof. A FedAvg process selects many local models for training. When the locally updated models are uploaded, the server averages the local model weights and uses that as the next global model that it then redistributes. A FedAvg process may involve one or more methods disclosed in J. Near and D. Darais, “Protecting Model Updates in Privacy-Preserving Federated Learning” (Cybersecurity Insights (an NIST blog) Jul. 15, 2024)), or one or more methods disclosed in J. McMahan et al., “Communication-Efficient Learning of Deep Networks from Decentralized Data” (Proceedings of the 20th International Conference on Artificial Intelligence and Statistics (AISTATS) 2017), both of which are hereby incorporated by reference and for all purposes. In a FedBuff process, all local models can be trained simultaneously even if some of the local models are training an old global model checkpoint (a stale model). FedBuff involves sending local model training gradients to the federated server instead of model weights, as this allows the federated ML algorithm(s) to scale the amount of influence of learnings from stale updates. A FedBuff process may involve one or more methods disclosed in J. Nguyen et al., “Federated Learning with Buffered Asynchronous Aggregation,” (Proceedings of the 25th International Conference on Artificial Intelligence and Statistics (AISTATS) 2022, Valencia, Spain. PMLR: Volume 151), which is hereby incorporated by reference and for all purposes;
1006: updates to the federated ML model 1005d during a training process;
1006a, 1006b and 1006c: updates to the local ML models 1005a, 1005b and 1005c during training processes;
1007a, 1007b and 1007c: updated federated ML model data sent to the local ML models 1005a, 1005b and 1005c by the federated ML model 1005d; and
1008a, 1008b and 1008c: updated local ML model data sent to the federated ML model 1005d.

According to some examples, the updated federated ML model data 1007a, 1007b and 1007c may be, or may include, neural network parameter weights, neural network parameter gradients, or combinations thereof. The local ML models 1005a, 1005b and 1005c may, for example, be trained on local data using back propagation. When a local model is updated using federated ML model data, the previous local model may be deleted and updated with a copy of the latest (most recent) federated model. Local training may then be done on this copy of the latest federated model. In some alternative examples, a local model may be configured to take a weighted sum of the present local model and the latest federated model. Such alternative examples have a potential advantage: the local model may not lose as much local specialization that the local model has learnt from its specific environment would be lost if the previous local model were deleted and updated with a copy of the latest federated model.

The local ML models 1005a, 1005b and 1005c may each be implemented by an instance of the apparatus 150 of FIG. 1. As noted above, the data 1002a, 1002b and 1002c may include user engagement data, sensor data, or both. According to some examples, the data 1002a, 1002b and 1002c may include time data, such as time stamps, corresponding to time data of the content 603. According to some examples, devices in the preview environments 701a, 701b and 701c may be configured to determine, for example based on user preference data, selected user engagement data, selected sensor data, or both, to provide to the local ML models 1005a, 1005b and 1005c.

Implementations such as those shown in FIG. 10 have some potential advantages. For example, one level of privacy protection may be obtained by allowing OPC previewers to determine which user engagement data, which sensor data, or both, to provide to a local ML model. Another level of privacy protection may be obtained by having the federated ML model 1005d trained on the updated local ML model data 1008a, 1008b and 1008c, instead of user engagement data, sensor data, or both, received directly from individual preview environments.

Although not expressly shown in FIG. 10, the OPC 601c may be configured to prepare and output an ad report 604, a content report 605, or both. In some examples, the OPC 601d may be configured to generate the ad report 604 and the content report 605 based on the output of the federated machine learning ML model 1005d.

FIG. 11 shows example elements of a content report. As with other figures provided herein, the types, numbers and arrangements of elements shown in FIG. 11 are merely provided by way of example. Other implementations may include more, fewer and/or different types, numbers and arrangements of elements.

According to this example, the content report 605 of FIG. 11 includes the following elements:
1101: a section of the Content Report 605 summarizing report details such as the content type, the content title, the content duration, the number of participants in the analysis and the average rating provided by the users;
1102: a section of the Content Report 605 detailing the demographical distribution of the audience that previewed the supplied content 603, including the audience percentages by country, gender distributions, general interests and genre preferences;
1103: a section of the Content Report 605 with a range of detailed summary views;
1103a: a subsection of the summary view section 1103 that includes an interactive engagement analysis; and
1103b: a subsection of the summary view section 1103 that includes a summary of character engagement feedback.

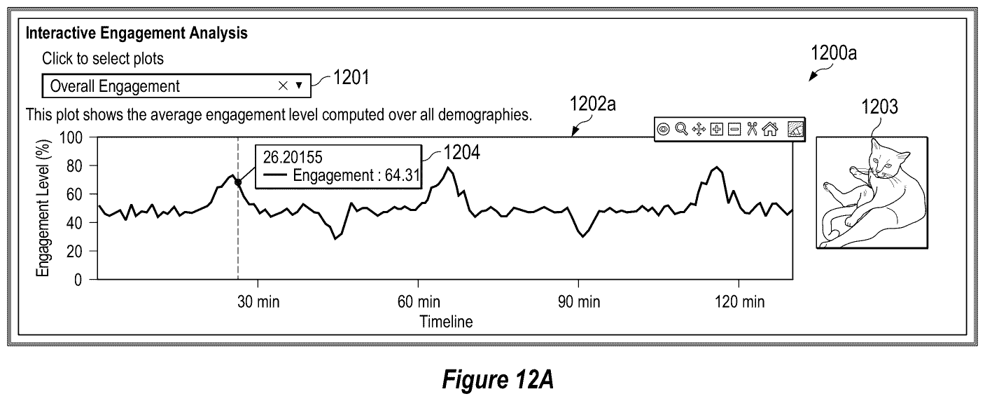

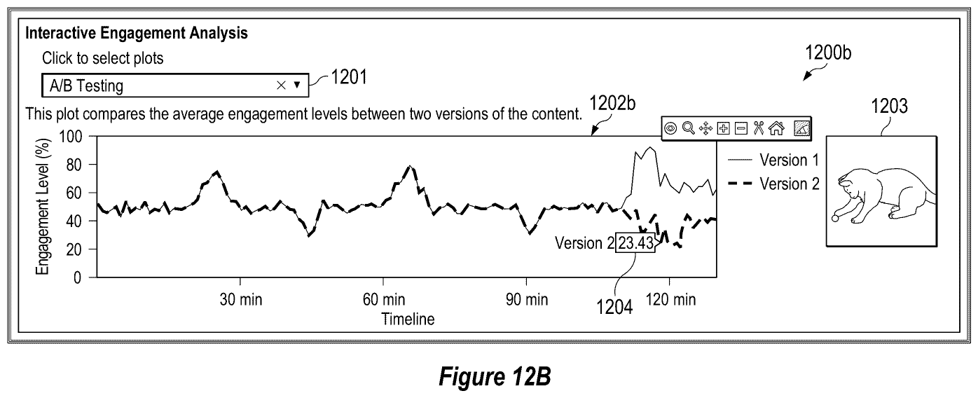

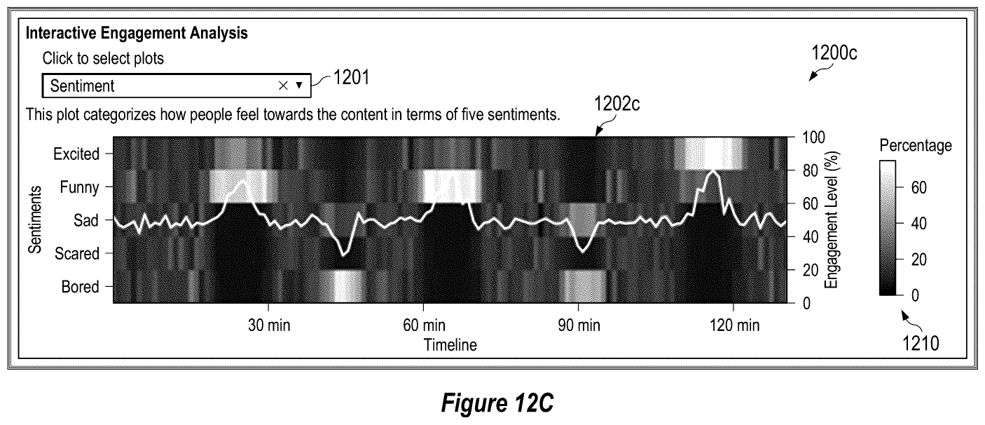

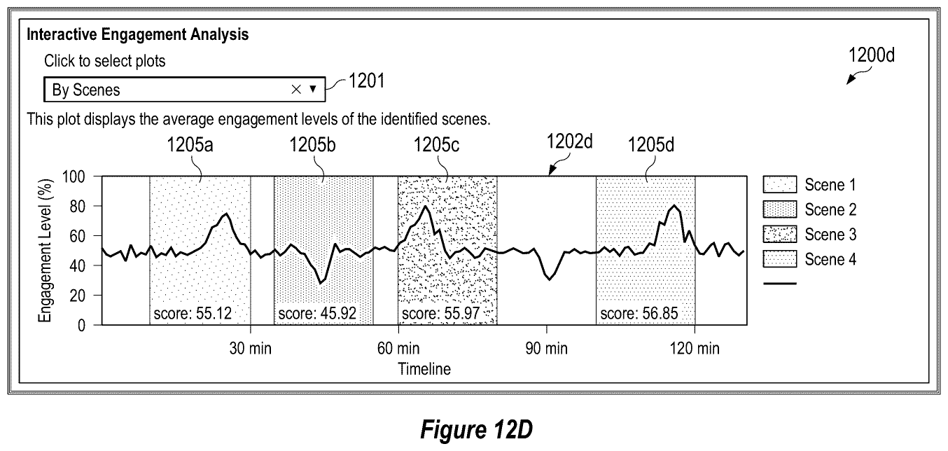

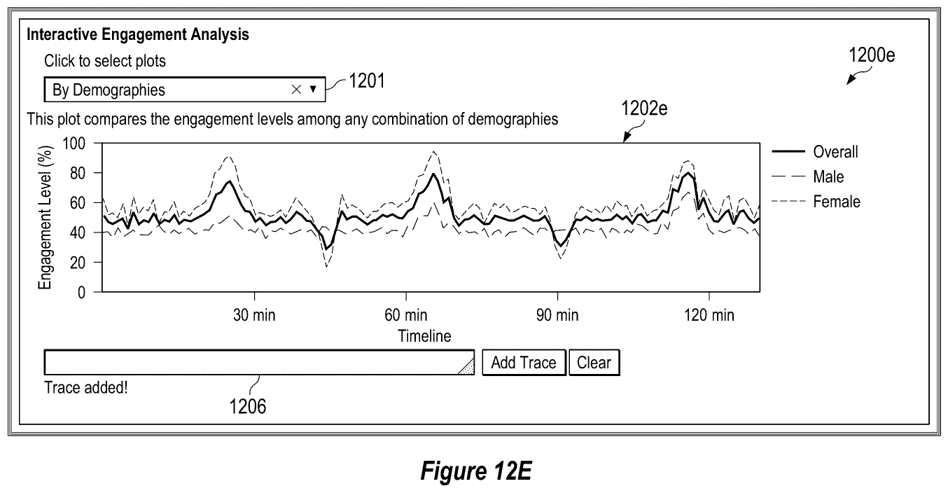

FIG. 12A shows an example of a graphical user interface (GUI) for presenting an interactive engagement analysis. As with other figures provided herein, the types, numbers and arrangements of elements shown in FIG. 12A are merely provided by way of example. Other implementations may include more, fewer and/or different types, numbers and arrangements of elements.

FIG. 12A shows an example of an interactive engagement analysis GUI 1200a showing the overall engagement over a timeline corresponding to an entire a piece of content 603. In this example, the interactive engagement analysis GUI 1200a corresponds with the subsection 1103a of the content report 605 that is shown in FIG. 11. FIG. 12A depicts the interactive engagement analysis GUI 1200a during a time at which a user is interacting with the interactive engagement analysis GUI 1200a—for example, by touch, by clicking a cursor, by “hovering” a cursor, etc.—in order to evaluate overall engagement at a particular time, which is indicated by the vertical dashed line in the graph 1202a.

According to this example, the interactive engagement analysis GUI 1200a includes the following elements:
1201: a section dropdown that allows a user to select from different interactive engagement analysis categories and corresponding views. In this example, the user has selected the “overall engagement” category by interacting with the section dropdown 1201;
1202a: a graph showing the overall engagement of previewers over the duration of the content. The trace in the graph 1202a shows the example metric “engagement level (%)” corresponding to the selected the “overall engagement” category;
1203: a thumbnail displaying what was occurring in the content 603 at the time selected by a user; and
1204: a readout of the overall engagement level of previewers at the time selected by the user.

FIG. 12B shows another example of a GUI for presenting an interactive engagement analysis. As with other figures provided herein, the types, numbers and arrangements of elements shown in FIG. 12B are merely provided by way of example. Other implementations may include more, fewer and/or different types, numbers and arrangements of elements.

FIG. 12B shows an example of an interactive engagement analysis GUI 1200b showing A/B testing results for versions 1 and 2 of an ending portion of a piece of content 603. FIG. 12B depicts the interactive engagement analysis GUI 1200b during a time at which a user is interacting with the interactive engagement analysis GUI 1200b in order to evaluate overall engagement with version 2 at a particular time, which is indicated by the readout 1204.

According to this example, the interactive engagement analysis GUI 1200b of FIG. 12B includes the following elements:
1201: a section dropdown that allows a user to select from different interactive engagement analysis categories and corresponding views. In this example, the user has selected the “A/B testing” category by interacting with the section dropdown 1201;
1202b: a graph showing the overall engagement of previewers over the duration of multiple versions of the content. In this example, two versions of the content were tested. The results for version 1 are shown via a solid trace and the results for version 2 are shown via a dashed trace;
1203: a thumbnail displaying what was occurring in version 2 of the content 603 at the time selected by a user; and
1204: a readout of the overall engagement level of previewers at the time selected by the user.

FIG. 12C shows another example of a GUI for presenting an interactive engagement analysis. As with other figures provided herein, the types, numbers and arrangements of elements shown in FIG. 12C are merely provided by way of example. Other implementations may include more, fewer and/or different types, numbers and arrangements of elements.

FIG. 12C shows an example of an interactive engagement analysis GUI 1200c showing summarized previewer sentiment results for an entire piece of content 603. According to this example, the interactive engagement analysis GUI 1200c includes the following elements:
1201: a section dropdown that allows a user to select from different interactive engagement analysis categories and corresponding views. In this example, the user has selected the “sentiment” category by interacting with the section dropdown 1201;
1202c: a graph showing a trace indicating the overall engagement of previewers over the duration of an entire piece of content 603 overlaid on summarized previewer sentiment results for an entire piece of content 603. On the left-hand side of the graph 1202c, along the y axis, the names of five different sentiments are listed, which are “excited,” “funny,” “sad,” “scared” and “bored” in this example. Each named sentiment corresponds to previewer sentiment results for a row of the graph 1202c; and
1210: a scale that indicates how to interpret the sentiment levels shown in the graph 1202c. For instance, audiences found around 90 minutes into the content 603 to be either a bit sad or a bit boring.

FIG. 12D shows another example of a GUI for presenting an interactive engagement analysis. As with other figures provided herein, the types, numbers and arrangements of elements shown in FIG. 12D are merely provided by way of example. Other implementations may include more, fewer and/or different types, numbers and arrangements of elements.

FIG. 12D shows an example of an interactive engagement analysis GUI 1200d showing per-scene previewer sentiment results piece of content 603. According to this example, the interactive engagement analysis GUI 1200d includes the following elements:
1201: a section dropdown that allows a user to select from different interactive engagement analysis categories and corresponding views. In this example, the user has selected the “by scenes” category by interacting with the section dropdown 1201;
1202d: a graph showing a trace indicating the overall engagement of previewers over the duration of an entire piece of content 603; and
1205a, 1205b, 1205c and 1205d: highlighted scenes, each of which shows an average engagement level for the corresponding scene.

FIG. 12E shows another example of a GUI for presenting an interactive engagement analysis. As with other figures provided herein, the types, numbers and arrangements of elements shown in FIG. 12E are merely provided by way of example. Other implementations may include more, fewer and/or different types, numbers and arrangements of elements.

FIG. 12E shows an example of an interactive engagement analysis GUI 1200e showing per-demographic previewer sentiment results piece of content 603. According to this example, the interactive engagement analysis GUI 1200e includes the following elements:
1201: a section dropdown that allows a user to select from different interactive engagement analysis categories and corresponding views. In this example, the user has selected the “by demographics” category by interacting with the section dropdown 1201;
1202e: a graph showing a trace indicating the overall engagement of previewers in selected demographic groups over the duration of an entire piece of content 603; and
1206: a tool with which a user may interact to select groups for which the user would like to add traces to the graph 1202e. In this example, a user has selected “Female” and “Male” demographic groups and corresponding traces have been added to the graph 1202e.

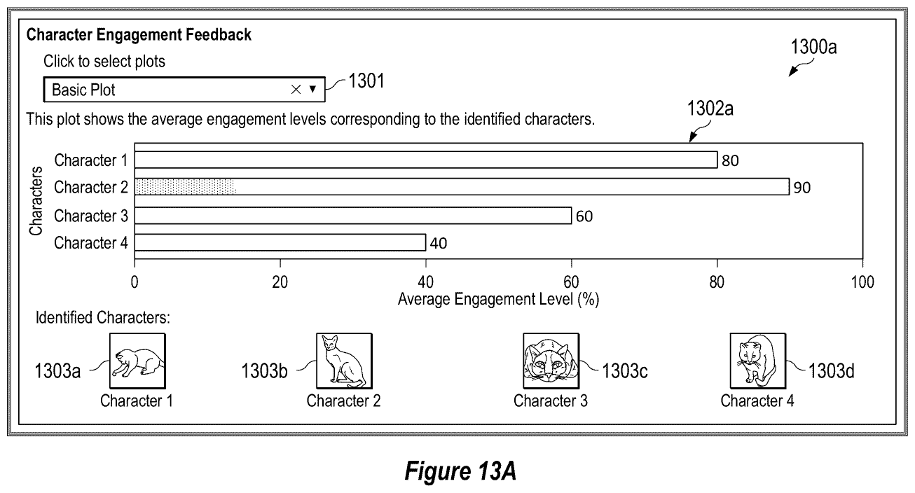

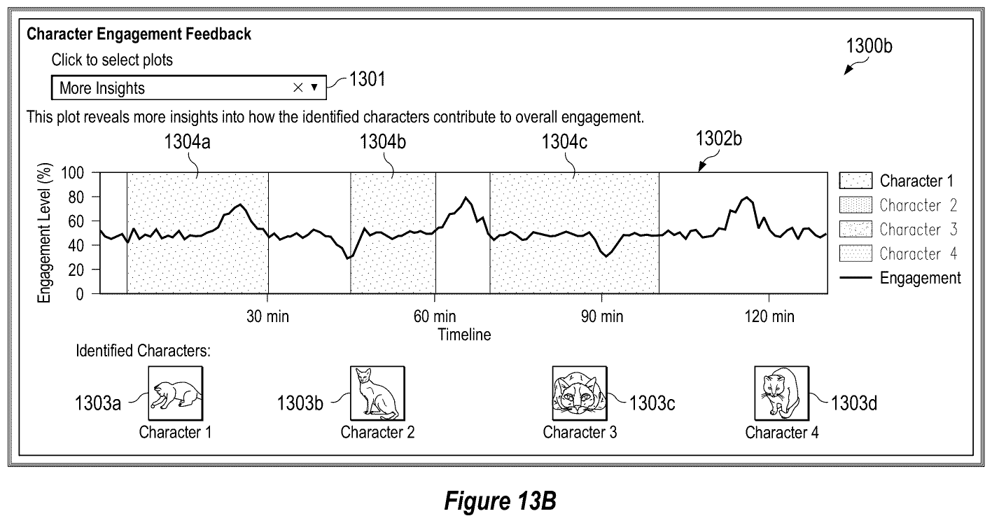

FIG. 13A shows an example of a GUI for presenting a character-specific engagement analysis. As with other figures provided herein, the types, numbers and arrangements of elements shown in FIG. 13A are merely provided by way of example. Other implementations may include more, fewer and/or different types, numbers and arrangements of elements.

FIG. 13A shows an example of an interactive engagement analysis GUI 1300a showing per-demographic previewer sentiment results piece of content 603. According to this example, the interactive engagement analysis GUI 1300a includes the following elements:
1301: a section dropdown that allows a user to select from different character engagement analysis categories and corresponding views. In this example, the user has selected the “basic plot” category by interacting with the section dropdown 1301;
1302a: a graph showing the average engagement of previewers with characters 1, 2, 3 and 4. The x axis of graph 1302a shows an example metric “Average Engagement Level (%)”; and
1303a, 1303b, 1303c and 1303d: thumbnails corresponding to characters 1, 2, 3 and 4.

FIG. 13B shows another example of a GUI for presenting a character-specific engagement analysis. As with other figures provided herein, the types, numbers and arrangements of elements shown in FIG. 13B are merely provided by way of example. Other implementations may include more, fewer and/or different types, numbers and arrangements of elements.

FIG. 13B shows an example of an interactive engagement analysis GUI 1300b showing information regarding how identified characters contribute to overall previewer engagement with a piece of content 603. In this example, the interactive engagement analysis GUI 1300b highlights the engagement level of previewers during scenes starring a selected character. According to this example, the interactive engagement analysis GUI 1300b includes the following elements:
1301: a section dropdown that allows a user to select from different character engagement analysis categories and corresponding views. In this example, the user has selected the “more insights” category by interacting with the section dropdown 1301;
1302b: a graph showing the engagement level of previewers during scenes starring a selected character, which is character 1 in this example. Highlighted regions appear on the graph 1302b corresponding to segments during which the selected character appeared in the content;
1303a, 1303b, 1303c and 1303d: thumbnails corresponding to characters 1, 2, 3 and 4; and
1304a, 1304b and 1304c: A plurality of highlighted regions on the plot where the selected character appeared.

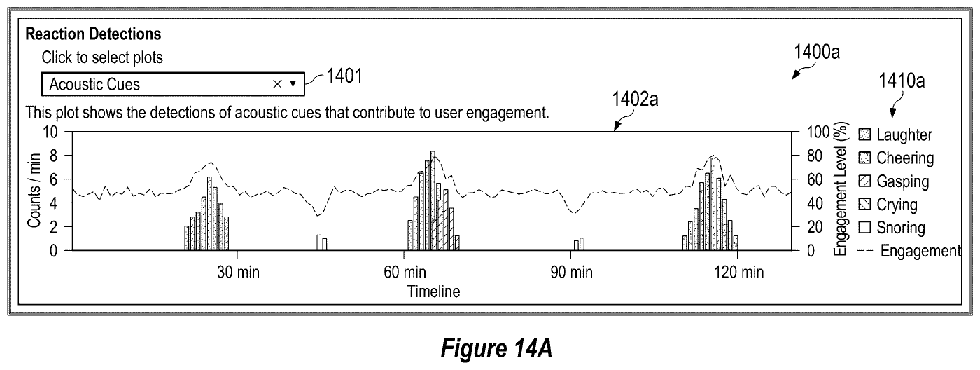

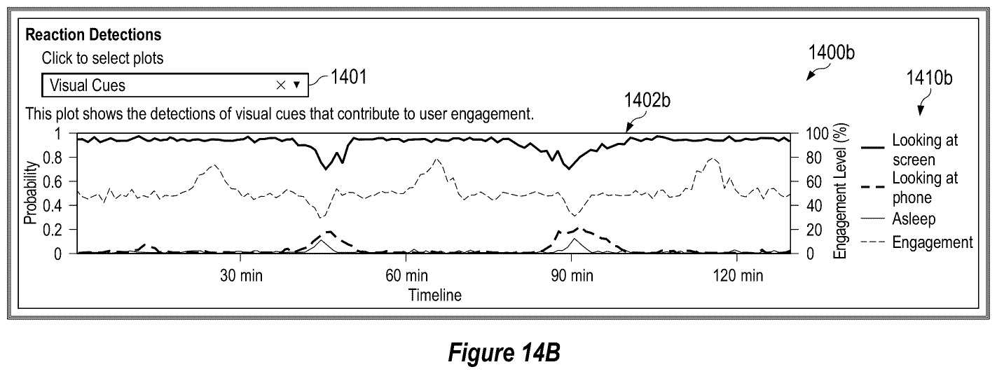

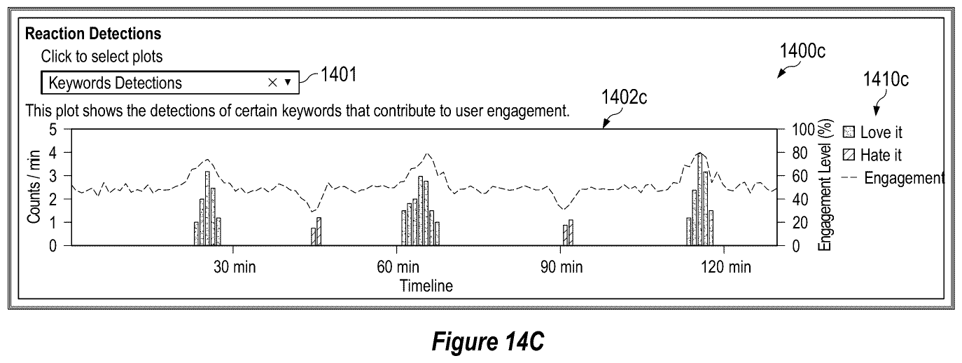

FIG. 14A shows an example of a GUI for presenting an engagement analysis corresponding to various detected previewer reactions. As with other figures provided herein, the types, numbers and arrangements of elements shown in FIG. 14A are merely provided by way of example. Other implementations may include more, fewer and/or different types, numbers and arrangements of elements.

FIG. 14A shows an example of an interactive engagement analysis GUI 1400a showing reactions from previewers that were observed when a piece of content 603 was being consumed. According to this example, the interactive engagement analysis GUI 1400a includes the following elements:
1401: a section dropdown that allows a user to select from different reaction detections categories and corresponding views. In this example, the user has selected the “acoustic cues” category by interacting with the section dropdown 1401;
1402a: a graph showing the engagement level of the previewers across the duration of the content 603—indicated by the dashed trace—and vertical bars corresponding to acoustic cue histograms for various types of acoustic cues from previewers that were detected at various times during the presentation of a piece of content 603; and
1410a: a key that shows bar types corresponding to example acoustic cue histograms.

FIG. 14B shows another example of a GUI for presenting an engagement analysis corresponding to various detected previewer reactions. As with other figures provided herein, the types, numbers and arrangements of elements shown in FIG. 14B are merely provided by way of example. Other implementations may include more, fewer and/or different types, numbers and arrangements of elements.

FIG. 14B shows an example of an interactive engagement analysis GUI 1400b showing additional reactions from previewers that were observed when a piece of content 603 was being consumed. According to this example, the interactive engagement analysis GUI 1400b includes the following elements:
1401: a section dropdown that allows a user to select from different reaction detections categories and corresponding views. In this example, the user has selected the “visual cues” category by interacting with the section dropdown 1401;
1402b: a graph showing the engagement level of the previewers across the duration of the content 603 and traces corresponding to various types of visual cues from previewers that were detected at various times during the presentation of a piece of content 603. In this example, the visual cue types are “looking at screen,” “looking at phone” and “asleep”; and
1410b: a key that shows line types corresponding to the various traces shown in the graph 1402b.

In some instances, previewers may explicitly indicate their current level of engagement and/or sentiment. Such indications may be achieved through some form of intentional engagement such as verbally (e.g., “love it”, “hate it”), pressing a button (e.g., on TV remote, in a smart device application), gesturing to a camera (e.g., giving a thumbs up or down), etc.

FIG. 14C shows an example of a GUI for presenting an engagement analysis corresponding to detected previewer reactions that explicitly indicate current levels of engagement. Known keywords are an example of how users may explicitly convey how they feel during content playback. As with other figures provided herein, the types, numbers and arrangements of elements shown in FIG. 14C are merely provided by way of example. Other implementations may include more, fewer and/or different types, numbers and arrangements of elements.

FIG. 14C shows an example of an interactive engagement analysis GUI 1400c showing additional reactions from previewers that were observed when a piece of content 603 was being consumed. According to this example, the interactive engagement analysis GUI 1400c includes the following elements:
1401: a section dropdown that allows a user to select from different reaction detections categories and corresponding views. In this example, the user has selected the “keyword detections” category by interacting with the section dropdown 1401;
1402c: a graph showing a dashed trace indicating the overall engagement level of previewers across the duration of the content 603 and keyword detection histograms corresponding to instances of two keyword phrases uttered by previewers being detected at various times during the presentation of a piece of content 603. In this example, the keyword phrases are “love it” and “hate it”; and
1410c: a key that shows a line type corresponding to the trace in the graph 1402c indicating the overall engagement level of previewers, as well as bar types corresponding to the keyword phrases “love it” and “hate it.”

FIG. 15A shows example elements of a portion of an ad report. As with other figures provided herein, the types, numbers and arrangements of elements shown in FIG. 15A are merely provided by way of example. Other implementations may include more, fewer and/or different types, numbers and arrangements of elements.

In this example, the ad report portion 604a provides information regarding relevant demographics to target for advertising. According to this example, the ad report portion 604a includes the following elements:
1501a: A graph showing a trace indicating the overall engagement of previewers over the duration a content presentation. The trace in black shows the example metric “Engagement Level (%)”. The graph 1501a also shows highlighted regions indicating which time intervals might be the best for placing an ad, for example during the types in which viewers are most or least engaged;
1502a, 1502b, 1502c, 1502d and 1502e: a plurality of highlighted regions indicating time intervals during which people of specific identified demographics and interests are estimated to have been the most or the least engaged with the content.

FIG. 15B shows example elements of another portion of an ad report. As with other figures provided herein, the types, numbers and arrangements of elements shown in FIG. 15B are merely provided by way of example. Other implementations may include more, fewer and/or different types, numbers and arrangements of elements.

In this example, the ad report portion 604b provides information regarding when and how people that have known interests engaged with the content 603. According to this example, the ad report portion 604b includes the following elements:
1501b: A graph showing the engagement levels of previewers over the duration the content 603 by interest. Along the y axis of the graph 1501b, the names of four different interests are listed, with each type of interest corresponding to a row of the graph 1501b. In this example, the interest types are “cars,” “cooking,” “fashion” and “sports”; and
1510b: a scale that indicates how to interpret the average engagement levels of people who had a particular interest. For instance, audiences that are interested in fashion or cars found were highly engaged around 26 minutes into the content 603.

FIG. 15C shows example elements of another portion of an ad report. As with other figures provided herein, the types, numbers and arrangements of elements shown in FIG. 15C are merely provided by way of example. Other implementations may include more, fewer and/or different types, numbers and arrangements of elements.

In this example, the ad report portion 604c provides information regarding when and how people from various countries engaged with the content 603. According to this example, the ad report portion 604c includes the following elements:
1501c: A graph showing the engagement levels of previewers over the duration the content 603 by country. Along the y axis of the graph 1501c, the names of four different countries are listed, with each country corresponding to a row of the graph 1501c. In this example, the countries are Australia, England, South Korea and the United States; and
1510c: a scale that indicates how to interpret the average engagement levels of people from a particular country at a particular time.

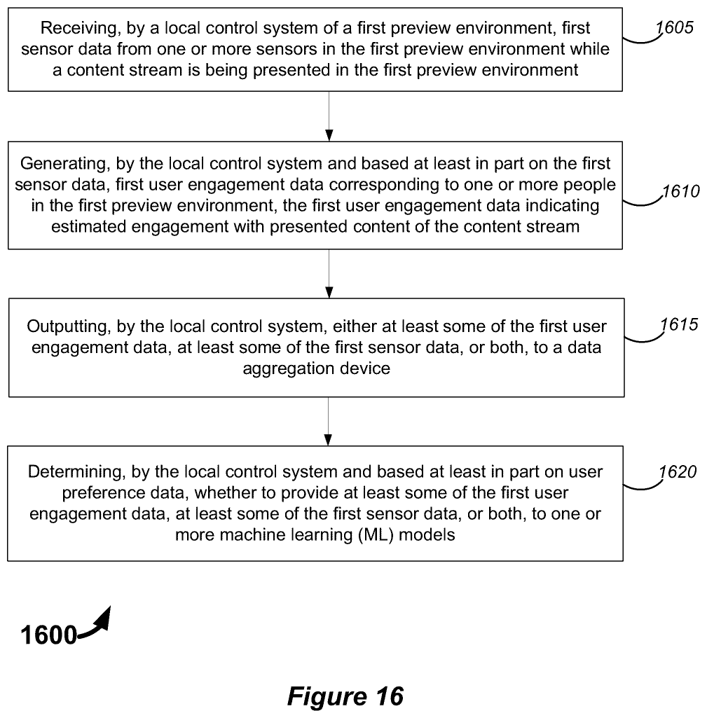

FIG. 16 is a flow diagram that outlines one example of a disclosed method. Method 1600 may, for example, be performed by the control system 160 of FIG. 1. The blocks of method 1600, like other methods described herein, are not necessarily performed in the order indicated. According to some examples, one or more blocks may be performed in parallel. Moreover, some similar methods may include more or fewer blocks than shown and/or described.

In some examples, the blocks of method 1600 may be performed—at least in part—by one or more devices within a preview environment, e.g., by a head unit (such as a TV) or by another component of a preview environment, such as a laptop computer, a game console or system, a mobile device (such as a cellular telephone), etc. However, in some implementations at least some blocks of the method 1600 may be performed by one or more devices that are configured to implement a cloud-based service, such as one or more servers.

In this example, block 1605 involves receiving, by a local control system of a first preview environment, first sensor data from one or more sensors in the first preview environment while a content stream is being presented in the first preview environment. The content stream may, for example, correspond to a television program, a movie, an advertisement, music, a podcast, a gaming session, a video conferencing session, an online learning course, etc. In some examples, in block 1605 the control system may obtain the first sensor data from one or more sensors of the sensor system 180 disclosed herein. The first sensor data may include sensor data from one or more microphones, one or more cameras, one or more eye trackers configured to collect gaze and pupil size information, one or more ambient light sensors, one or more heat sensors, one or more sensors configured to measure galvanic skin response, etc.

According to this example, block 1610 involves generating, by the local control system and based at least in part on the first sensor data, first user engagement data corresponding to one or more people in the first preview environment. In this example, the first user engagement data indicates estimated engagement with presented content of the content stream. In some examples, block 1610 may be performed, at least in part, by one or more Device Analytics Engines (DAEs). The user engagement data estimated in block 1610 may, for example, include probabilities of detected acoustic events (such as the unit probabilities 408 representing the posterior probabilities of acoustic events described with reference to FIG. 4), emotion type estimations, heart rate estimations, body pose estimations (such as the pose probabilities 503 described with reference to FIG. 5), one or more latent space representations of sensor signals, etc. According to some examples, the user engagement data estimated in block 1610 may include attentiveness scores, such as data indicating whether or not a person is looking at a screen that is displaying video content. Some examples may involve additional steps of processing of detected acoustic events, Viterbi decoding, to enable the detection of key words a user has spoken. For example, the content producers may supply key words they want previewers to respond with throughout the session. Such additional processing of detected acoustic events may allow the detection of such key words.

In this example, block 1615 involves outputting, by the local control system, either at least some of the first user engagement data, at least some of the first sensor data, or both, to a data aggregation device. In some examples, block 1615 may involve outputting either at least some of the first user engagement data, at least some of the first sensor data, or both, to multiple data aggregation devices. According to some examples, the data aggregation device may be the aggregator 703 that is described with reference to FIG. 7, or a similar device.

In some examples, the data aggregation device(s) may be, or may include, one or more other devices that is used to implement aspects of an OPC, such as one or more other devices that are configured to receive and store the stored data 1003a, the stored data 1003b and/or the stored data 1003c that are described with reference to FIG. 8, one or more other devices that are configured to aggregate the stored data 1003a, the stored data 1003b and the stored data 1003c into the data 1004 that is input to the federated machine learning (ML) model 1005, etc.

According to this example, block 1620 involves determining, by the local control system and based at least in part on user preference data, whether to provide at least some of the first user engagement data, at least some of the first sensor data, or both, to one or more machine learning (ML) models. In some examples, one of the one or more ML models may be a first local ML model, implemented by the first local control system. Examples of the first local ML model include the local ML models 1005a, 1005b and 1005c of FIGS. 9 and 10. The first local ML model may be configured to be trained, at least in part, on at least some of the first user engagement data, at least some of the first sensor data, or both, from the first preview environment. According to some examples, the first local control system may be configured to implement the first local ML model.

Alternatively, or additionally, one of the one or more ML models may be a federated ML model that is configured to be trained at least in part on user engagement data from a plurality of preview environments, sensor data from a plurality of preview environments, or both. Federated ML model 1005 of FIG. 8 and federated ML model 1005d of FIG. 10 are examples of the federated ML model are. In some such examples, the federated ML model may be implemented by one or more remote devices that are not in the first preview environment. For example, the federated ML model may be implemented by one or more servers.

According to some examples, method 1600 may involve receiving, by the first local control system and from the federated ML model, updated federated ML model data and updating, by the first local control system, the first local ML model according to the updated federated ML model data. In some examples, the updated federated ML model data may correspond to a demographic group of at least one of the one or more people in the first preview environment.

Method 1600 may or may not involve training the first local ML model, based on the particular implementation. In other words, the first local ML model may or may not be trained based, at least in part, on at least some of the first user engagement data, at least some of the first sensor data, or both, from the first preview environment. According to some examples, method 1600 may involve determining, by the first local control system, to provide the first user engagement data, the first sensor data, or both, to the first local ML model. In other examples, method 1600 may involve determining, by the first local control system, not to provide the first user engagement data, not to provide the first sensor data, or determine not to provide either, to the first local ML model. However, in some such examples, method 1600 may nonetheless involve receiving, by the first local control system and from the federated ML model, the updated federated ML model data and updating the first local ML model according to the updated federated ML model data.

In some examples, the federated ML model may be configured to be trained, at least in part, on updated local ML model data from each of a plurality of local ML models. According to some such examples, each of the plurality of local ML models may correspond to one preview environment of a plurality of preview environments.

According to some examples, method 1600 may involve determining, by the first local control system, when to provide updated local ML model data from the first local ML model. In some examples, method 1600 may involve determining, by the first local control system, to provide updated local ML model data from the first local ML model after the first local ML model has processed user engagement data, sensor data, or both, from a complete session of content consumption in the first preview environment. According to some examples, method 1600 may involve determining, by the first local control system, to provide updated local ML model data from the first local ML model after the first local ML model has updated user engagement data according to one or more user responses to one or more user prompts.

In some examples, method 1600 may involve determining, by the first local control system, to provide selected sensor data to the first local ML model. The selected sensor data may include some, but not all, types of sensor data obtained in the first preview environment. The selected sensor data may, for example, correspond to user preference data obtained by the first local control system.

According to some examples, method 1600 may involve generating, by the first local control system, the first user engagement data according to a set of one or more detectable engagement types obtained by the first local control system. In some examples, the set of one or more detectable engagement types may correspond to user preference data obtained by the first local control system. Alternatively, or additionally, the set of one or more detectable engagement types may correspond to detectable engagement data provided with the content stream. In some examples, the detectable engagement data may be indicated by metadata received with the content stream. According to some examples, first detectable engagement data corresponding to a first portion of the content stream may differ from second detectable engagement data corresponding to a second portion of the content stream. The first portion of the content stream may correspond to a first scene, segment, etc., of the content stream and the second portion may correspond to a second scene, segment, etc., of the content stream.

In some examples, method 1600 may involve providing one or more user prompts. According to some examples, each of the one or more user prompts may correspond to a time interval of the content stream. In some such examples, the one or more user prompts may be, or may include, requests for express user input regarding user engagement, such as clarification of whether a user's expression—which may be shown on a display along with a prompt—corresponded to positive or negative user engagement. In some examples, method 1600 may involve receiving responsive user input corresponding to at least one of the one or more user prompts. According to some examples, method 1600 may involve generating at least some of the first user engagement data based, at least in part, on the responsive user input.

### Detectable Attentions Lists and Metadata

The potential short list of detectable attention as described briefly in the introduction is detailed further in this section. The range of detectable attention may be specified in a list. Examples of the types of attention that may appear in this list could be in one of the following forms:

A specific response where the user does the exact thing. For example, the user says “Yes,” “No” or something that does not match, or the user can be detected raising either the left or right hand or neither.

A type of response, where the reaction has some level of a match to the type of response. For example, a user may be requested to “start moving” and the target attention type is movement from the user. In this case, detecting the user wiggling around would be a strong match. Another example could involve the content saying, “Are you ready?” to which the content is looking for an affirmative response. There may be many valid user responses that suggest affirmation, such as “Yes,” “Absolutely,” “Let's do this” or a head nod.

An emotional response, where the user's emotion or a subset of their emotions are detected. For example, a content provider wishes to know the sentiment consumers had towards their latest release. They decide to add emotion to the short-list of detectable attention. Users consuming the content start to have a conversation about the content and only the sentiment is derived as an attribution to their emotional reaction. Another example involves a user who only wants to share emotion level on the dimension of elatedness. When the user is disgusted by the content they are watching, there disgust is not detected. However, a low level of elatedness is reflected in the attention detections.

A topic of discussion, where the ATS determines what topics arose in response to the content. For example, content producers want to know what questions their movie raises for audiences. After listing the topic of discussion as an attention listed option, they find that people generally talk about how funny the movie is or about global warming.

There may be more attention types in some examples. The attention lists may be provided from a range of different providers, such as a device manufacturer, the user, a content producer, an advertiser, etc. If many detectable attention lists are available any way of combining these lists may be used to determine a resulting list, such as a user list only, a union of all lists, the intersection of the user's list and the content provider's list, etc.

The detectable attention lists may also provide the user with a level of privacy, where the user can provide their own list of what they would like to be detectable and provide their own rules for how their list is combined with external parties. For instance, a user may be provided with staged options (for example, via a GUI and/or one or more audio prompts) as to what is detected from them, and they select to have only emotional and specific responses detected. This makes the user feel comfortable about using their ATS-enabled device(s).

The list of detectable attention indications may arrive to the user's device in several ways. Two examples include:

The list of detectable attention indications is supplied in a metadata stream of the content to the device.

There is a list of detectable attention indications pre-installed in the user's ATS-enabled device(s) which may be applicable to a wide range of content and user attention indications. In some examples, the user may be able to select from these detectable attention indications, e.g., as described above.

The list of detectable attention indications associated with a segment of content may be learnt from users who have their ATS-enabled their device to detect a larger set of attention indications from them. In this way, content providers can discover how users are attending to their content and then add these attention indication types to the list they wish to detect for users with a more restricted set of detectable attention indications. In some examples, there may be an upstream connection alongside the content stream that allows this learnt metadata to be sent to the cloud to be aggregated.

The option to have lists of detectable attention indications is applicable to all the use cases listed in the “Example Use Cases” section.

### Personalization and Augmentation Using Engagement Feedback Use-Cases

### Example Use Cases

### Determining a User's Preferences

Suppose that one or more users consume a range of content on a playback device with an ATS. In some examples, the content-related preferences of each user may be determined over time by aggregating results from the ATS. Preferences that can be tracked may vary widely and could include content types, actors, themes, effects, topics, locations, etc. The user preferences may be determined in the cloud or on the users' ATS-enabled device(s). In some instances, the terms “user preferences,” “interests” and “affinity” may be used interchangeably.

Short-term estimations of what a user is interested in may be established before long-term aggregations of user preferences are available. Such short-term estimations may be made through recent attention information and hypothesis testing using the attention feedback loop.

### Next-Iteration Personalization of Content by Producers Based on Reactions

Content producers provide content that can be watched by consumers at any time. A content producer may be provided with information regarding how users in ATS-enabled environments have attended to their content. This information may, in some examples, be used by the content producer to provide a personalised spin to the next iteration of the content (e.g., episode, album, story).

### Specific Examples

An influencer receives attention metrics regarding their previous short video and find that users were highly attentive and want to see more products like one they had displayed. The influencer decides to present a similar product for their viewers in the next short.

A vlogger making a series of videos around a video game asks the viewers, “What character should I play as next time?” at the end of his video. The viewers indicate (e.g., vocally, pointing) what character they'd like to see them play next time. The vlogger then makes the decision of what to play as next time with these attention results in mind.

A TV show ends on an open-ended cliff-hanger. Based on the ATS user responses, there were four primary types of response to the ending. The TV show producers use this information and decide to make four versions of the next episode. The users are shown the version of the episode that is intended for them based on how they reacted to the previous episode.

### Advertising Using Attention Feedback Use Cases

Previously-deployed advertising systems have limited ways to determine a user's attention. Some current methods include having a user click an advertisement (“ad”), having a user choose whether or not to skip an ad, and having a trial audience fill out a survey about the ad. According to such methods, the advertiser does not necessarily know if a user is even present when an ad is presented.

Utilizing an ATS allows for better-informed advertising. Better-informed advertising may result in the improvements of current techniques such as advertising performance, advertising optimization, audience sentiment analysis, tracking of user interests, informed advertising placement, etc.

### Informed Advertising Placement Based on User Attention

The placement of advertising can be informed using attention information as detected by an ATS. We use “advertising placement” to mean when to place advertising and what advertising to place. Choices of advertising placement may be decided using long-term trends and optimizations or in real time using information about how the user is engaging at that moment. Moreover, a combination of the two may be used, where real-time decisions of advertising placement may be optimized over the long term. Examples of decisions that may be made using this information include:

Placing advertising where users are least engaged with the content, as to minimise the annoyance of the ads.

Placing advertising where users are most engaged with the content, as to maximise the attention to the ads.

Placing advertising about a topic when the topic is present in the content.

Placing advertising about a product when users with interests in that product type are engaged with the content.

Optimize advertising placement based on the affect it has on the ad's or content's performance using a closed loop enabled by the ATS.

Combinations of any of the above.

Learnt decision making of advertising placement could be done at different levels, such as:
per user (e.g., preferring advertising at the start of content);
per population type (e.g., Gen Z viewers, or viewers in France, jazz fans);
per scene (e.g. certain users are more likely to engage with ads when a specific user is on screen: A Tag Heuer ad with Ryan Gosling following a scene in which Ryan Gosling is on screen for users that respond to the scene);
per episode (e.g., the least annoying part to receive an ad in this episode is learnt);
per series (e.g., maximal attention is generally five minutes before the episode ends);
and so on.

### Specific Examples

An original equipment manufacturer (OEM) that produces ATS-enabled device components sells attention information to broadcasters. The broadcaster then sells advertising spaces based on the level of attention for the space.

A mobile phone video game produces revenue through advertising other games during playback. The game studio that produces the video game determines that users are the least engaged after finishing a battle in the game, using ATS-enabled mobile phones. The game studio wants to minimize the annoyance of ads, and so decide to place the advertising after battles are finished.

A TV show production company values the viewing experience of their shows. For this reason, they want to optimize advertising placement as to maximise the content's performance. The production company uses the attention level after ad breaks to determine the effect of the ad placement on the show. Some attention types they may look out for include a user being excited the show has returned, all users have left the room and are not present, a user is now more engaged with their phone, etc.

### Deriving Contextual Advertising Metadata for Content Based on User Engagement

This section provides examples of how contextual metadata for content may be used to infer how people may react to advertising. Contextual metadata may correspond to and/or indicate the context of a scene (for example, actor(s) present, mood (for example, happy, funny, somber, dramatic, scary, etc.) topic(s) involved, etc.), engagement analytics aligned with demographic information, engagement analytics aligned with user preferences, etc. Contextual metadata for content may be used to inform advertising placement. Moreover, the contextual metadata may be pre-learnt from previous viewers to inform advertising placement for current viewers whose device may not be ATS-enabled.

According to some examples, the contextual metadata may be learnt from users of ATS-enabled devices, preferably with their demographic information shared to the OPC. The learnt contextual metadata may, in some examples, be subsequently delivered with the content upon the full release of the content, allowing for contextually-informed advertising to be provided with the content as soon as the content is released.

### Specific Examples

One thousand North American women aged between 25 and 40 who like cars, each watch a movie. Their engagement is tracked over time with an ATS as they watch the movie. For example, the ATS may log each time they laugh. This is used to determine the top 5 most suitable locations in this movie to place a funny ad relevant to North American women aged between 25 and 40 who like cars.
500 German men aged between 20 and 30 who like kitesurfing each watch a documentary about extreme sailing. The ATS may log whether they are looking at the screen at any given moment. Corresponding ATS data may be used to estimate the optimum time(s) during the extreme sailing video to place an ad for kitesurfing harnesses.

### Content Performance Assessment Using Attention Feedback Use Cases

Current content performance assessment methods generally involve having a test audience preview content. Obtaining metrics through test audiences have many drawbacks, such as requiring manual labor (e.g., reviewing surveys), being non-representative of the final viewing audience and possibly being expensive. In this section we will detail how these issues can be overcome through the use of an Attention Tracking System (ATS).

Having an ATS allows one to determine exactly how a user responds to content as it is playing back. The ATS may be used in end-user devices, making all content consumers a test audience, reducing content assessment costs and eliminating the issue of having a non-representative test audience. Additionally, analytics produced by an ATS do not require manual labor. Because the analytics are collected automatically in real time, content can be automatically improved by machines. However, the option to optimize content by hand is still an option. Furthermore, using an ATS during a content improvement process may form a closed loop in which decisions made using the attention information can have their effectiveness tested by utilizing the ATS another time. Examples of how an ATS can be leveraged for content performance assessment and content improvement are detailed in this section.

In this section of the disclosure, we refer to a type of metadata that specifies where certain attention responses are expected from users. For example, laughter may be expected at a timestamp or during a time interval. In some examples, a mood may be expected for an entire scene.

In some implementations, a performance analysis system may take in the expected level of reactions to content, as specified by content creators and/or statistics of reactions detected by ATS, to then output scores which can act as a content performance metric.

An event analyser may take in attention information (such as events, signals, embeddings, etc.) to determine key events in the content that evoked a response from the user(s). For example, the event analyser may perform clustering on reaction embeddings to determine the regions or events in the content where users reacted with similar responses. In some examples, a probe embedding may be used to find times where similar attention indications occurred.

### Example Use Cases

### Added Values for Content Creators

The ‘Content Performance Assessment Using Attention Feedback Use Cases’ section focuses on the values to the content creator added by the ATS. By implementing ATS, there are several aspects that may benefit content creators and content providers. These include:

Content performance assessment; and

Content improvement.

### Content Performance Assessment

### Assess Content Performance Based on User Attention

The performance of content may be determined using attention metrics coming from users' ATSs. For example, having users lean forwards whilst looking at a screen that is providing content would demonstrate user interest in the content. However, having a user talk on a topic unrelated to the content could mean they are uninterested. Such information about user attention to the content may be aggregated to gain insights on how users overall are responding. The aggregated insights may be compared to the results from other pieces or sections of content to compare performance. Some examples of pieces or sections of content include episodes, shows, games, levels, etc. Differences in levels of attention may reveal useful content performance insights. Moreover, the attention information may indicate what users are attending to (e.g., theme, object, effects, etc.). Note that any content performance assessments obtained using an ATS could be used in conjunction with traditional methods of assessment such as surveys.

### Assess Content Performance Using Authored Metadata

Another extension of “Assess content performance based on user attention” is where the potential user responses are listed in the metadata. Suppose that one or more users are watching content (e.g., an episode of a Netflix series) on a playback device with an associated ATS. The ATS may be configured by metadata in a content stream to detect particular classes of response (e.g., laughing, yelling “Yes,” “oh, my god”).

In some examples, content creators or editors may specify what are the expected responses from audiences. Content creators or editors may also specify when the reactions are expected, for example, a specific timestamp (e.g., at the end of a punchline, during a hilarious visual event such as a cat smoking), during a particular time interval, for a category of event type (e.g., a specific type of joke) or for the entire piece of content.

According to some examples, the expected reactions may be delivered in the metadata stream alongside the content. There may also be a library of user response types—for example, stored within the user's device, in another local device or in the cloud—that may be applicable to many content streams, which can be applied more broadly. The metadata of what attention indications are expected may be the attention indications that are exclusively listened for and are permitted by the user, in order to give the user more privacy and provide the content producer and provider with the desired attention analytics.

The user reactions to the content—in some examples, aligned with the metadata—may then be collected. Statistics based on those reactions and metadata may be used to assess the performance of the content. Example assessments for particular types of content include:

### Jokes

Content creators add metadata specify the places where a ‘laughter’ response is expected from audiences. Laughter may even be broken down into different types, such as ‘belly laugh,’ ‘chuckle,’ ‘wheezer,’ ‘machine gun,’ etc. Additionally, content creators may choose to detect other verbal reactions, such as someone who repeats the joke or tries to predict the punchline.

During content streaming, in some examples the metadata may inform the ATS to detect whether a specific type of laughter reaction occurs. Statistics of the responses may then be collected from different audiences. A performance analysis system may then use those statistics to assess the performance of the content, which may serve as useful feedback to content creators. For example, if the statistics show a particular segment of a joke or skit did not gain many laughter reactions from audiences, it means the performance of this segment needs to be improved.

### Scares

During a horror movie, responses such as ‘oh my god’, a visible jump or a verbal gasp may be expected from audiences. An analysis of ATS information gathered from this authored metadata may reveal a particular segment of a scary scene gained little frightened response. This may indicate the need to improve that portion of the scary scene.

### Controversial Topics

Some channels stream debates about different groups, events and policies that may receive a lot of comments and discussions. During content streaming, the metadata informs the ATS to detect whether a supportive or debating reaction is presented. Statistics of user responses may then be collected from different audiences. Such ATS data may help the content creators to analyse the reception of the topics.

### Provocative Scenes

Content creators may add metadata specifying the places in a content presentation where they expect strong negative responses from audiences, such as “oh, that's disgusting” or turning their head away. This may be of use in horror movies, user-generated “gross out” content, etc. During content streaming, such as a video containing a person eating a spider, in some examples the metadata may inform the ATS to detect if a provocative reaction occurs. The aggregated data may show that users were not responding with disgust during the scene. The content creators may decide that extra work needs to be done to make the scene more provocative.

### Magnificent Scenes

Content producers add metadata may specify the places in a content presentation where they expect strong positive responses such as “wow,” “that is so beautiful,” etc., from audiences. This technique may be of use for movies, sport broadcasting, user generated content, etc. For example, in a snowboarding broadcast, slow motions of highlight moments are expected to receive strong positive reactions. Receiving information of user reactions from the ATS and analysis from data aggregation may give insights to content creators. The content creators can determine whether the audience likes the content or not, and then adjust the content accordingly.

### Assess Content Performance Using Learnt Metadata

Another extension of “Assess content performance using authored metadata” is where the metadata is learnt from user attention information. During content playback, ATSs may collect responses from the audience. Statistics of the responses may then be fed into an event analyzer in order to help create meaningful metadata for the content. The metadata may, for example, be produced according to one or more particular dimensions (e.g., hilarity, tension). The event analyzer may, in some instances, decide what metadata to add using techniques such as peak detection to determine where an event might be occurring. Authored metadata may already exist for the content, but additional learnt metadata may still be generated using such disclosed methods.

### Specific Examples

A live stand-up comedy show has all the jokes marked up in the metadata through information coming from ATS-enabled devices.

A show already authored with metadata has additional metadata learnt using ATS-enabled devices. The additional metadata reveals that audiences were laughing at an unintentionally funny moment. The content producers decide to accentuate this moment.

### Assess Content Based on A/B User Engagement Testing

The collection of real reactions from audiences using ATS-enabled devices can provide metrics for A/B testing. Obtaining useful data can be achieved using techniques detailed in the ‘Content Performance Assessment’ section. Three different examples of such A/B testing are described below. In one example, there are different versions of the content sent to previewer. In another example, the content remains the same but the audience differs. In a third example, the testing is done as a Monte Carlo experiment. The responses collected can help differentiate what difference, if any, certain factors make on the content's performance.

### A/B Testing Versions of Content

When A/B testing different versions of content, any change to the content may be made. Some examples include:
one version out of many different versions of a scene may be selected for each user
a paragraph may be optionally omitted in an audio book;
two different characters could potentially be killed in a battle, but only one character is selected per user;
different colour grading options may be applied to a movie for different users.

Following are examples of A/B testing different versions of content:

Determining the relative importance of elements in a joke. There are many elements that make a joke amusing. By changing those elements in a reel and gathering reactions from the same type of audience, insights of the relative importance of elements in a joke may be revealed. This type of testing may allow the content producers to figure out what people find amusing about their humour.

Test audiences are randomly served version A or B of a piece of content. A content report is produced using an OPC. Content producers may decide whether to release version A or version B based, at least in part, on their respective performance.

### A/B Testing Content Across Demographics

It can be useful to collect statistics that reflect people's content preferences across demographics, which ultimately can be used to create more interesting content targeted to specific groups. The influence of different cultures, environments, and so on, may alter peoples' preferences of content type by region. Tests can be conducted using the ATS to collect responses of different audiences by region. Insights of the preferences may be revealed by the statistics. For example, sarcastic jokes may receive more laughter in a particular region whilst another region may be less responsive. This may suggest that content that includes a lot of sarcastic jokes may be well-suited for the former region, however an adapted version having fewer sarcastic jokes may be advisable for the latter region to improve the overall enjoyment in that area.

It is a sensible assumption that people of different ages will prefer different types of content. The ATS can serve as a means to collect expected reactions, and as a metric to test whether or not the targeted audience favours a particular type of content.

A specific example is a comedy that has a joke that bombs for people aged 30 to 40 but performs well for people aged 50 to 60. The content producers of the comedy may decide to make different versions of their comedy depending on their demographics, which may involve replacing that joke for the 30 to 40 year-old age demographic.

### A/B Testing Content Across User Preferences and Interests

Similar to A/B testing content across demographics, content may be tested across user preferences. The user preferences may be determined using an ATS using methods described in the ‘Determining a user's preferences’ section or they may be explicitly specified by the person. Using this information, one may test how content is received by viewers with different interests (e.g., likes cars, hates cats, loves pizza). This information may help content producers to determine what type of people like the content and what people are not interested due to conflicting preferences.

### Monte Carlo Experiments

A/B testing via Monte Carlo experiments may include multiple random factors. Some such random factors may include target region, demographic groups, length of content, types of content, etc. Statistics may be extracted from collected individual reactions and from the overall aggregated data for all the random factors. A/B testing via Monte Carlo experiments may, for example, be appropriate for the brainstorming phase of production. A/B testing via Monte Carlo experiments may also be useful for identifying salient factors that might not otherwise have been considered.

Providing Content Producers with User Engagement Analytics Using a Preview Service

One significant aspect of the present disclosure involves providing content assessment via a preview service, such as an OPC. For example, a company may run a preview service in which media content (e.g., TV shows, podcasts, movies) is shown to participants in an OPC. Each participant may have a preview environment that includes a preview device and one or more microphones. In some instances, the preview environment may include one or more cameras. The one or more microphones, one or more cameras, etc., may provide data for an ATS. According to some examples, when people sign up to be participants in an OPC, they may provide demographically relevant information such as their age, gender, location, favourite film and/or television series genres, interests (e.g., cars, sailing, sports, wine, watches, etc).

Participants registering for the preview service may, in some examples, be explicitly informed that microphones and/or cameras and other sensors will be used to determine their engagement while they are watching and thus will be able to make an informed decision about whether the privacy trade-off is worthwhile, given the chance to see exciting new content.

After content has been shown on the OPC, in some examples the content producers will be provided with detailed engagement analytics and accurate demographical information, which may in some examples be as described with reference to FIGS. 11-15C. The engagement analytics may be of a temporal granularity that allows the content producers to see how users engaged with the content throughout the duration of the content presentation. For example, the engagement analytics may provide information regarding scene-by-scene engagement, may provide an engagement score for each time of a plurality of intervals (e.g., every 1 second, every 2 seconds, every 3 seconds, every 4 seconds, every 5 seconds, every 6 seconds, every 8 seconds, every 10 seconds, etc.). According to some examples, the engagement analytics may include one or more information summaries.

In some examples, a preview service may be hosted by a third party to the content producers. For example, the third party may be an entity that provides engagement measurement and analytics as a service. In such examples, content producers could request to have their content shown on the preview service, may be able to select one or more types of demographics, regions, etc., of interest to the content producers.

According to some examples, A/B user engagement testing such as disclosed herein may be provided. In some such examples, content producers may list multiple versions of their content to be previewed in the service. Content producers can make use of the detailed engagement analytics in order to decide which variant of a piece of content to release publicly, in order to inform modifications to a piece of content (e.g., remove a joke, change an actor), in order to plan which new pieces of content to produce, etc.

### Content Improvement

### Automatically Optimize Content Based on Crowdsourced User Engagement

Based on the techniques listed in the ‘Content Performance Assessment’ section, an OPC implementing ATS instances may serve as a crowdsourced evaluation process. The content may, in some examples, be broadcasted to participants in the OPC. There may be assessment metrics associated with the content. Instead of inviting audiences to watch a pre-release version of the content as a group in a single environment, the pre-release version of the content can be released to a small audience to obtain a fast evaluation. Using evaluation information obtained via the OPC, the content may be quickly—and in some examples, automatically—optimized. The automatic optimization via OPC may involve a full release of the content or a release of the content, depending on the particular instance. As detailed in the “A/B testing versions of content” section, automatic optimizations may involve a variety of options, such as changing a sequence (e.g., replacing a scene, trimming the length of a scene), changing an effect (e.g., volume, brightness), etc.

### Specific Example:

A content producer pays to have their comedy automatically optimized on an OPC. Based on participant feedback, one of the jokes is detected to have clearly flopped. The joke is automatically removed from the content, to amend the jarringly unfunny moment. The adjusted content is then sent back to the content producer.

### Continuous Improvement of Content Based on User Engagement

The methods described in the “Improve content based on A/B user engagement testing” and “Automatically optimize content based on crowdsourced user engagement” sections may involve a closed loop that the ATS forms via allowing content producers to obtain engagement analytics for each iteration of their content. Such implementations can provide insights into how the adjustments to the content were received. A step-by-step breakdown of the process according to one example follows:

The content is streamed by many users and their engagements are detected using ATS-enabled devices.

Engagement information is aggregated by a cloud-based service, which provides insights into how the content was received and how it should be adjusted.

The content is adjusted either automatically or by hand.

The new version or versions of the content are released to users.

The cycle repeats.

Methods such as the foregoing allow for continual improvement of the content. The optimisations to the content may also target different demographics based on the responses of the respective audiences. In some examples, human input may be incorporated with automatically optimized content, for example human inspection of the quality of the adjusted content, human provision of additional options for A/B testing, etc.

Some aspects of present disclosure include a system or device configured (e.g., programmed) to perform one or more examples of the disclosed methods, and a tangible computer readable medium (e.g., a disc) which stores code for implementing one or more examples of the disclosed methods or steps thereof. For example, some disclosed systems can be or include a programmable general purpose processor, digital signal processor, or microprocessor, programmed with software or firmware and/or otherwise configured to perform any of a variety of operations on data, including an embodiment of disclosed methods or steps thereof. Such a general purpose processor may be or include a computer system including an input device, a memory, and a processing subsystem that is programmed (and/or otherwise configured) to perform one or more examples of the disclosed methods (or steps thereof) in response to data asserted thereto.

Some embodiments may be implemented as a configurable (e.g., programmable) digital signal processor (DSP) that is configured (e.g., programmed and otherwise configured) to perform required processing on audio signal(s), including performance of one or more examples of the disclosed methods. Alternatively, embodiments of the disclosed systems (or elements thereof) may be implemented as a general purpose processor (e.g., a personal computer (PC) or other computer system or microprocessor, which may include an input device and a memory) which is programmed with software or firmware and/or otherwise configured to perform any of a variety of operations including one or more examples of the disclosed methods. Alternatively, elements of some embodiments of the inventive system are implemented as a general purpose processor or DSP configured (e.g., programmed) to perform one or more examples of the disclosed methods, and the system also includes other elements (e.g., one or more loudspeakers and/or one or more microphones). A general purpose processor configured to perform one or more examples of the disclosed methods may be coupled to an input device (e.g., a mouse and/or a keyboard), a memory, and a display device.

Another aspect of present disclosure is a computer readable medium (for example, a disc or other tangible storage medium) which stores code for performing (e.g., coder executable to perform) one or more examples of the disclosed methods or steps thereof.

While specific embodiments of the present disclosure and applications of the disclosure have been described herein, it will be apparent to those of ordinary skill in the art that many variations on the embodiments and applications described herein are possible without departing from the scope of the disclosure described and claimed herein. It should be understood that while certain forms of the disclosure have been shown and described, the disclosure is not to be limited to the specific embodiments described and shown or the specific methods described.

What is claimed is:

1. An apparatus, comprising:
an interface system; and
a first local control system of a first preview environment, the first local control system being configured to:
receive, via the interface system, first sensor data from one or more sensors in the first preview environment while a content stream is being presented in the first preview environment;
generate, based at least in part on the first sensor data, first user engagement data corresponding to one or more people in the first preview environment, the first user engagement data indicating estimated engagement with presented content of the content stream;
output, via the interface system, either at least some of the first user engagement data, at least some of the first sensor data, or both, to a data aggregation device; and
determine, based at least in part on user preference data, whether to provide at least some of the first user engagement data, at least some of the first sensor data, or both, to one or more machine learning (ML) models.

2. The apparatus of claim 1, wherein one of the one or more ML models is a first local ML model that is configured to be trained at least in part on at least some of the first user engagement data, at least some of the first sensor data, or both, from the first preview environment.

3. The apparatus of claim 2, wherein the first local control system is configured to implement the first local ML model.

4. The apparatus of claim 3, wherein one of the one or more ML models is a federated ML model that is configured to be trained at least in part on user engagement data from a plurality of preview environments, sensor data from a plurality of preview environments, or both.

5. The apparatus of claim 4, wherein the federated ML model is implemented by one or more remote devices that are not in the first preview environment.

6. The apparatus of claim 4, wherein the federated ML model is implemented by one or more servers.

7. The apparatus of claim 5, wherein the first local control system is configured to receive, from the federated ML model and via the interface system, updated federated ML model data and to update the first local ML model according to the updated federated ML model data.

8. The apparatus of claim 7, wherein the first local control system determines to provide the first user engagement data or the first sensor data to the first local ML model.

9. The apparatus of claim 7, wherein the first local control system determines not to provide the first user engagement data or the first sensor data to the first local ML model.

10. The apparatus of claim 7, wherein the updated federated ML model data corresponds to a demographic group of at least one of the one or more people in the first preview environment.

11. The apparatus of claim 4, wherein the federated ML model is configured to be trained at least in part on updated local ML model data from each of a plurality of local ML models.

12. The apparatus of claim 11, wherein each of the plurality of local ML models corresponds to one preview environment of a plurality of preview environments.

13. The apparatus of claim 12, wherein the first local control system is configured to determine when to provide updated local ML model data from the first local ML model.

14. The apparatus of claim 13, wherein the first local control system is configured to provide updated local ML model data from the first local ML model after the first local ML model has processed user engagement data, sensor data, or both, from a complete session of content consumption in the first preview environment.

15. The apparatus of claim 13, wherein the first local control system is configured to provide updated local ML model data from the first local ML model after the first local ML model has updated user engagement data according to one or more user responses to one or more user prompts.

16. The apparatus of claim 3, wherein the first local control system is configured to provide selected sensor data to the first local ML model, wherein the selected sensor data comprises some, but not all, types of sensor data obtained in the first preview environment.

17. The apparatus of claim 16, wherein the selected sensor data corresponds to user preference data obtained by the first local control system.

18. The apparatus of claim 1, wherein the first local control system is configured to generate the first user engagement data according to a set of one or more detectable engagement types obtained by the first local control system and wherein the set of one or more detectable engagement types corresponds to user preference data obtained by the first local control system.

19. The apparatus of claim 1, wherein the first local control system is configured to generate the first user engagement data according to a set of one or more detectable engagement types obtained by the first local control system and wherein the set of one or more detectable engagement types corresponds to detectable engagement data provided with the content stream, is indicated by metadata received with the content stream, or both.

20. The apparatus of claim 19, wherein first detectable engagement data corresponding to a first portion of the content stream differs from second detectable engagement data corresponding to a second portion of the content stream
